(19) United States
(12) Patent Application Publication
(10) Pub. No.: US 2007/0014573 A1
(43) Pub. Date: Jan. 18, 2007

(54) Exchange structure and a method of connection configuration between the optical networks

(76) Inventors: Xueqin Wei, Hubei (CN); Bing Zhu, Hubei (CN); Zhifeng Wang, Hubei (CN)

Correspondence Address: FISH & RICHARDSON PC, P.O. BOX 1022, MINNEAPOLIS, MN, 55440-1022, US

(21) Appl. No.: 10/570,181

(22) PCT Filed: Sep. 1, 2003
(86) PCT No.: PCT/CN03/00735

§ 371 Date: Feb. 28, 2006

(51) Int. Cl. H04B 10/20

(52) U.S. Cl. 398/59

(57) ABSTRACT

The invention discloses an interconnection structure and a method for configuring path between the optical networks. The optical network includes a first network and a second network, the first network and the second network each has a number of nodes, a first node of the first network connects with a third node of the second network, a second node of the first network connects with a fourth node of the second network. The method comprises the steps of: setting-up a first path between one of the first node and the second node and another node of the first network; and at least by one link of the link between the first node and the third node and that between the second node and the fourth node, and by the first path, said another node of the first network communicates for path with another node of the second network. By the dual-node interconnection structure and the path configuration shceme of this invention between a ring network and a mesh network, and between mesh networks, the respective advantages of the ring network and the mesh metwork in regard to protection and restoration can be combined effectively, and the existing internetworking schemes between the rings are also compatible.

### FIELD OF THE INVENTION

The present invention relates to an interconnection structure, a path configuration scheme, and a path protection/restoration method between a mesh network and a ring network as well as between mesh networks, which can be applied to backbone networks, MAN (metropolitan area network), and access networks for optical communication. The ring network could be SDH/SONET, OADM (Optical Add Drop Multiplex), and ASON (Automatically Switched Optical Network); the mesh network could be O/O OXC (Optical Cross Connect) equipment, O/E/O OXC equipment, DXC (Digital Cross connect) equipment, and ASON. The interconnection structure is used for performing path interconnection and failure protection/restoration between a mesh network and a ring network as well as between mesh networks, and in a complicated networking situation including various ring networks and mesh networks.

### BACKGROUND ART

SDH/SONET ring networks with the aggregate interface transmission rate from 155 Mb/s, 622 Mb/s, 2.5 Gb/s to 10 Gb/s have been widely used in telecommunication networks, including long haul backbone networks, local networks and MAN. SDH ring network is a matured technology having some advantages like simple networking structure, fast ring protection responding time and high reliability. Now SDH equipment with transmission rate of 40 Gb/s is under development, it can be seen that SDH/SONET ring networks will exist for a long time and continue to grow.

There is a fast and reliable protection mechanism in SDH/SONET ring network. However, since 50 percent of resources are used for path protection in order to support such mechanism, the resource efficiency is low. When the second failure occurs over a link, some services on the network will be lost. These are an inherent characteristics of SDH/SONET due to its network structure.

For SDH/SONET networking application, real interconnection between networks mainly involves protection schemes such as SNCP (Subnetwork Connection Protection), MS-SP (multiplex section shared protection) ring, and Trail Protection etc. The protection schemes mentioned above are described in the relevant content of ITU-T standards G.841, G.783 and G.798. The dual-node interconnection structure and path configuration between ring networks are described in ITU-T standard G.842.

MS-SP ring includes 2-fiber MS-SP ring and 4-fiber MS-SP ring, and in actual applications mostly 2-fiber MS-SP ring is used. FIG. 1 illustrates a 2-fiber MS-SP ring, in which a half of the bandwidth over each fiber in the ring network is used to setup the working path, the other half of the bandwidth is used for protection. Because the protection bandwidth is shared by all sections, the ring is named as shared protection ring. The case with a bi-direction path between node A and node C in the ring will be exemplified for illustration purpose. When a failure takes place (for example, section failure between node B and node C), the nodes at both sides of the failure node will form a loop to pass the path affected by the failure using protection bandwidth, so the path will not be lost, as shown in FIG. 1(b). FIG. 1(a) shows a 2-fiber MS-SP ring under a normal working condition, FIG. 1(b) shows a 2 fiber MS-SP ring with a link failure.

FIG. 2 illustrates a dual-node interconnection between SNCP and MS-SP ring. The dual-node interconnection between ring networks are widely used in current networks as matured technology.

SNCP and end-to-end restoration are generally used in a mesh network. The situation when SNCP is used for the mesh network is basically same as that in a ring network, for example, the SNCP in the ring network as shown in FIG. 2. The end-to-end restoration is only used by a mesh network, as shown in FIG. 3. Referring to FIG. 3, the mesh network includes 9 nodes (node A through node I), there are two paths, path 1 and path 2 which have working paths A-B-C and G-H-I in the network, respectively. The backup paths for path 1 and path 2 are A-F-E-D-C and G-F-E-D-I, respectively, and the resource in F-E-D section is shared by the two services. The working path is represented by solid lines, and the backup path is represented by dashed lines. When a failure takes place on the working path of path 1 or 2, the end-to-end restoration will be accomplished by the backup path. When the two services fall into failure at the same time, only the path with higher priority will be restored because part of resource over the backup path is shared.

In addition, 1+1 path protection/SNCP is widely used in telecommunication networks including point-to-point networks, ring networks and mesh networks. In the case of 1+1 path protection/SNCP, the source node bridges a path to a working path and a backup path permanently, the destination node monitors the two paths simultaneously. When a failure takes place, the destination node will directly bridge to the backup path, hence it will take very little time.

Recently, with the fast development of ASON technology, mesh networks are showing more advantages over other optical networks. In addition to protection and restoration function similar to that of ring networks, mesh networks also have some other features like flexible path configuration, restoration, less resource reservation for path protection and restoration, high resource efficiency.

Because ring networks and mesh networks have different features, respectively, and most of present SDH/SONET transmission networks are networked and protected using a ring scheme, therefore SDH/SONET ring networks will still remain as an important choice for networking for a long period. However, as the development of ASON, mesh networks exhibit more advantages comparing with ring networks, hence for SDH/SONET transmission networks, the evolution from ring networks to mesh networks is becoming irreversible. Therefore, ring networks and mesh networks will co-exist in optical networks for a long time.

As mentioned above, the dual-node interconnection structure between ring networks is defined explicitly in IUT-T standard G.842. However, no research has been undertaken for the dual-node interconnection structure between a ring network and a mesh network as well as between mesh networks, and no related international standard is defined for such purpose.

In fact, a hybrid network consisting of SDH/SONET networks and mesh networks not only has features of a ring network, such as fast protection and high reliability, but also can improve the interconnectivity of the networks and provide more flexibility to path configuration. At the same time, the hybrid network can also protect the investment already made by network operators for current networks, and enable smooth evolution of the network infrastructure. Hence how to implement a dual-node interconnection between a mesh network and a ring network as well as between mesh networks is an issue that must be resolved during the course of network evolution.

### SUMMARY OF THE INVENTION

Due to the development of network technology and the evolvement of network, ring networks will co-exist with mesh networks for a long time. The present invention is aimed to provide a interconnection structure and a path configuration scheme between a ring network and a mesh network by using a dual-node interconnection (DNNI) scheme, and to provide a path protection/restoration method thereon. In addition, as popularity of mesh networks is increasing, the present invention is also aimed to provide a dual-node interconnection structure between mesh networks.

The present invention provides a method for configuring interconnection between optical networks including a first network and a second network each including a plurality of nodes, a first node of the first network being connected with a third node of the second network and a second node of the first network being connected with a fourth node of the second network, said method comprising the steps of: (a) setting-up a first path between one of the first node and the second node and another node in the first network; and (b) via the first path and at least one of the link between the first node and the third node and the link between the second node and the fourth node, setting up path between said another node in the first network and said another node in the second network.

The present invention also provides an inter-network interconnection structure, comprising: the first network having a plurality of nodes including the first node and the second node; the second network having a plurality of nodes including the thrid node and the fourth node, in which the first node is connected with the thrid node and the second node is connected with the fourth node; and the first path is adapted to connect the first node or the second node with the other node in the first network, in which path communication is carried out between the other node in the first network and the other node of the second network via the first path and at least one of the link between the first node and the thrid node and the link between the second node and the fourth node.

The dual-node interconnection topology can achieve high reliability, and transmission of services between a ring network and a mesh network will not be affected when a single point failure occurs in an interconnection node or over a link.

The ring network technology is a matured technology with features like simplicity of networking, fast protection, and high reliability. And a mesh network has similar protection and restoration function as a ring network, and has features such as high interconnectivity, good flexibility for path configuration, and high efficiency for utilizing resources. With the dual-node interconnection structure and the path configuring method of the present invention, the features possessed respectively by a ring network and a mesh network for protection and restoration can be combined advantageously, meanwhile the compatibility to the previous inter-ring connection scheme can be maintained.

Ring networks will co-exist with mesh networks for a long time. The interconnection structure and failure processing method according to the present invention are suitable for the interconnection of the inter-network path in the networking situation of mesh-ring, ring-mesh-ring, and mesh-ring-mesh, also suitable for the inter-network path interconnection in the networking scheme with the arbitrary combination of various mesh networks and ring networks regarding the above-mentioned various network topologies, and have very good robustness.

### BRIEF DESCRIPTION OF THE DRAWINGS

FIG. 1 shows a 2-fiber bi-direction MS-SP ring;

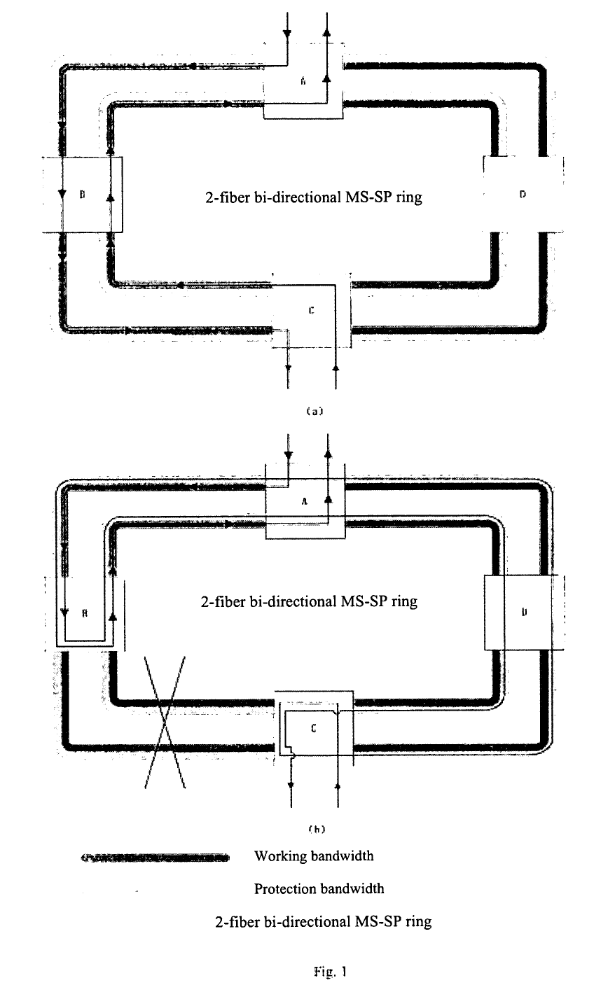

FIG. 2 shows a dual-node interconnection configuration between a SNCP ring and a MS-SP ring;

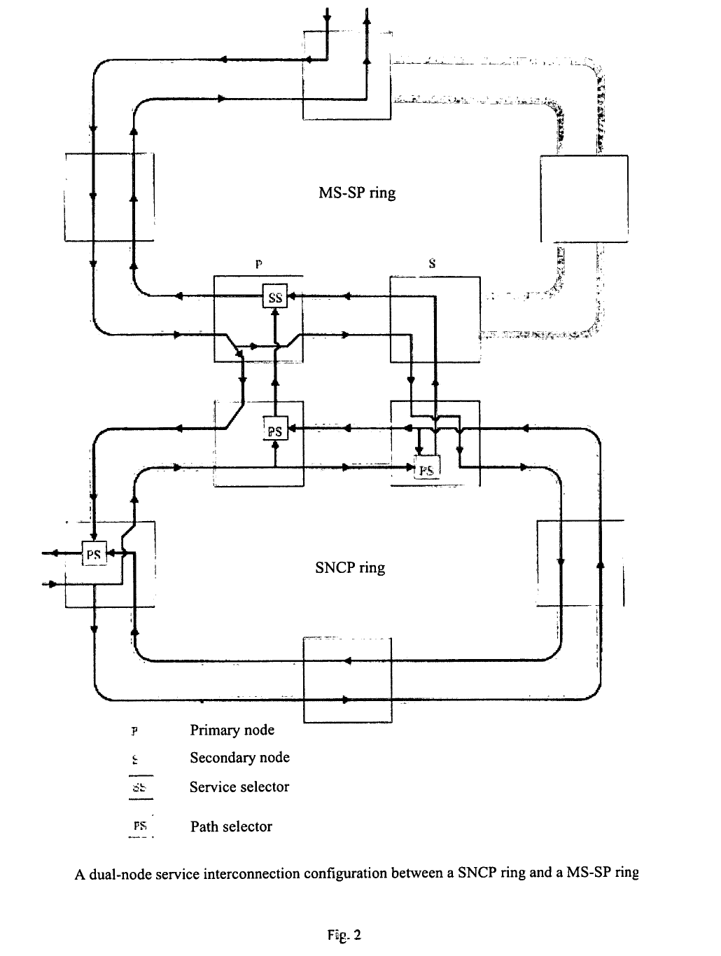

FIG. 3 shows an example of restoration in a mesh network;

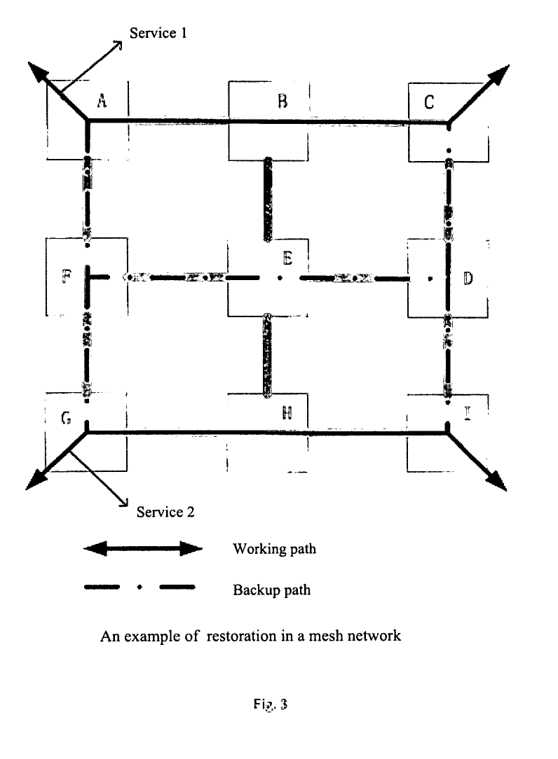

FIG. 4 shows a dual-node interconnection structure between a mesh network and a ring network: mesh-ring;

FIG. 5 shows a dual-node interconnection structure between ring networks and a mesh network: ring-mesh-ring;

FIG. 6 shows a dual-node interconnection structure between mesh networks and a ring network: mesh-ring-mesh;

FIG. 7 shows a dual-node interconnection structure between mesh networks: mesh-mesh;

FIG. 8 shows a dual-node interconnection between a MS-SP ring and a mesh network with SNCP protection;

FIG. 9 shows the first dual-node interconnection scheme between a MS-SP ring and a mesh network with restoration;

FIG. 10 shows the first dual-node interconnection scheme between a mesh network with restoration and a MS-SP ring (the selection of the primary node in the mesh network is different);

FIG. 11 shows the second dual-node interconnection scheme between a mesh network with restoration and a MS-SP ring;

FIG. 12 shows the second dual-node interconnection scheme between a mesh network with restoration and a MS-SP ring (the selection of the primary node in the mesh network is different);

FIG. 13 shows a dual-node interconnection between a mesh network and a ring network both with SNCP;

FIG. 14 shows the first dual-node interconnection scheme between a mesh network with restoration and a SNCP ring;

FIG. 15 shows the second dual-node interconnection scheme between a mesh network with restoration and a SNCP ring;

FIG. 16 shows a dual-node interconnection between MS-SP rings and a mesh network without protection in a ring-mesh-ring situation;

FIG. 17 shows a dual-node interconnection between SNCP rings and a mesh network without protection in a ring-mesh-ring situation;

FIG. 18 shows the first dual-node interconnection scheme between MS-SP rings and a mesh network with restoration in a ring-mesh-ring situation;

FIG. 19 shows the second dual-node interconnection scheme between MS-SP rings and a mesh network with restoration in a ring-mesh-ring situation;

FIG. 20 shows the first dual-node interconnection scheme between SNCP rings and a mesh network with restoration in a ring-mesh-ring situation;

FIG. 21 shows the second dual-node interconnection scheme between SNCP rings and a mesh network with restoration in a ring-mesh-ring situation;

FIG. 22 shows a dual-node interconnection between a MS-SP ring and mesh networks with SNCP in a mesh-ring-mesh situation;

FIG. 23 shows a dual-node interconnection between a SNCP ring and mesh networks with SNCP in a mesh-ring-mesh situation;

FIG. 24 shows the first dual-node interconnection scheme between a MS-SP ring and mesh networks with restoration in a mesh-ring-mesh situation;

FIG. 25 shows the second dual-node interconnection scheme between a MS-SP ring and mesh networks with restoration in a mesh-ring-mesh situation;

FIG. 26 shows the first dual-node interconnection scheme between a SNCP ring and mesh networks with restoration in a mesh-ring-mesh situation;

FIG. 27 shows the second dual-node interconnection scheme between a SNCP ring and mesh networks with restoration in a mesh-ring-mesh situation;

FIG. 28 shows the first dual-node interconnection scheme between a mesh network with restoration and a mesh networks with SNCP via a MS-SP ring in a mesh-ring-mesh situation;

FIG. 29 shows the second dual-node interconnection scheme between a mesh network with restoration and a mesh networks with SNCP via a MS-SP ring in a mesh-ring-mesh situation;

FIG. 30 shows the first dual-node interconnection scheme between a mesh network with restoration and a mesh networks with SNCP via a SNCP ring in a mesh-ring-mesh situation;

FIG. 31 shows the second dual-node interconnection scheme between a mesh network with restoration and a mesh networks with SNCP via a SNCP ring in a mesh-ring-mesh situation;

FIG. 32 shows a dual-node interconnection scheme between two mesh networks with SNCP;

FIG. 33 shows the first dual-node interconnection scheme between two mesh networks with restoration;

FIG. 34 shows the second dual-node interconnection scheme between two mesh networks with restoration;

FIG. 35 shows the first dual-node interconnection scheme between a mesh network with SNCP and a mesh network with restoration;

FIG. 36 shows the second dual-node interconnection scheme between a mesh networks with SNCP and a mesh network with restoration;

FIG. 37 shows an inter network link failure taken place when a SNCP ring and a mesh network with SNCP are dual-node interconnected;

FIG. 38 shows restoration of a single link failure in a mesh network;

FIG. 39 shows protection of a single link failure between networks;

FIG. 40 shows a single inter-network link failure that does not lead to protection and restoration;

FIG. 41 shows restoration for a node failure.

### DETAILED DISCRIPTION OF THE PREFERRED EMBODIMENTS

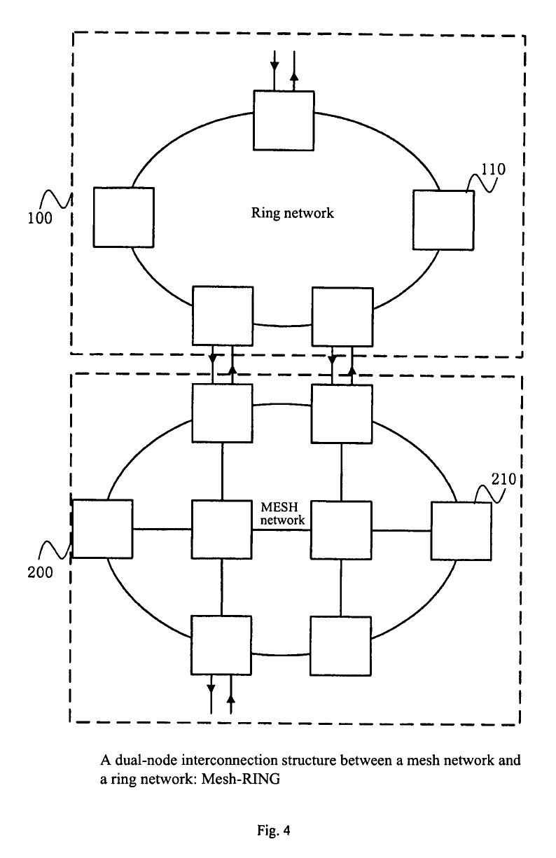

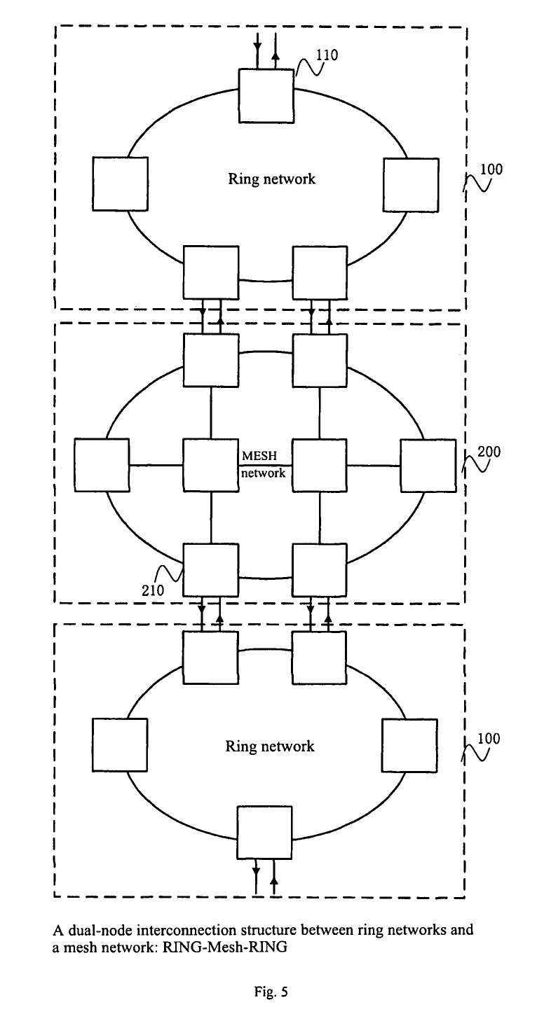

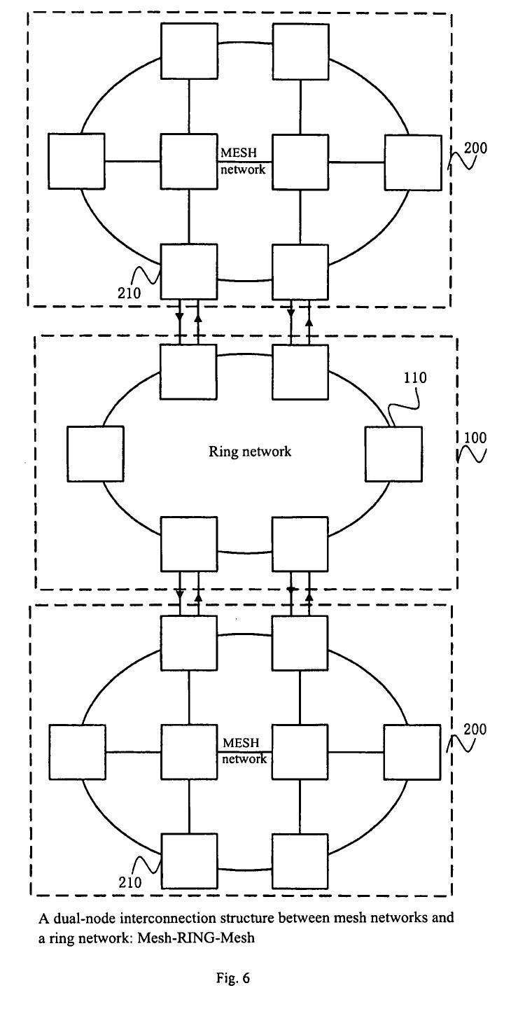

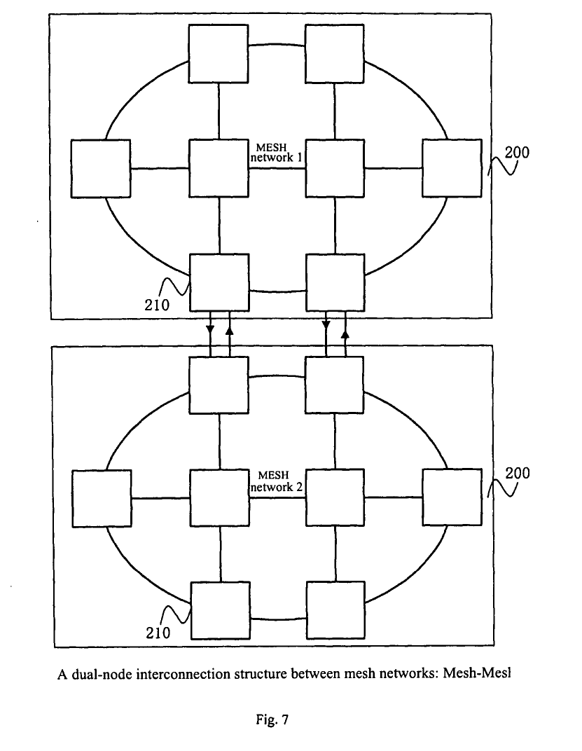

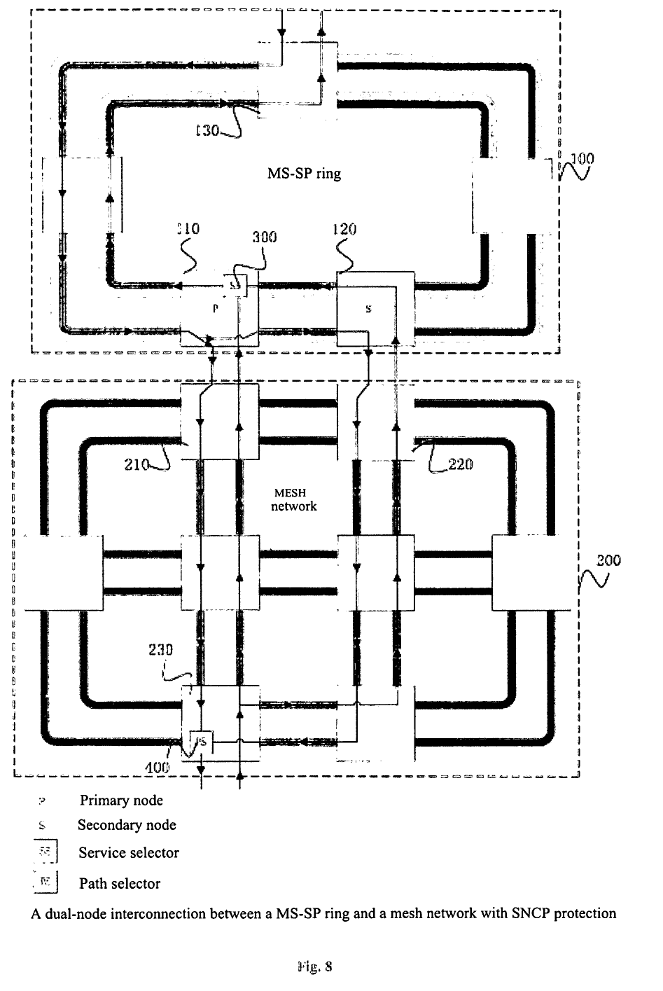

Referring to FIGS. 4, 5, 6 and 7, the interconnection structures with a variety of network topology are shown. The ring network 100 and the mesh network 200 each has two nodes for connecting to each other, and mesh networks can also be connected to each other by dual-node connection. FIG. 4 shows the topology structure in which a mesh network and a ring network are interconnected, FIG. 5 shows the topology structure in which two ring networks are interconnected through a mesh network, FIG. 6 shows the topology structure in which two mesh networks are interconnected through a ring network, and FIG. 7 shows the topology structure in which two mesh networks are interconnected. In the below embodiments, for ring networks, SNCP ring and MS-SP ring will be exemplified, and for mesh networks, SNCP and restoration will be exemplified. The different combinations of above-mentioned cases are shown in FIG. 8 through FIG. 36.

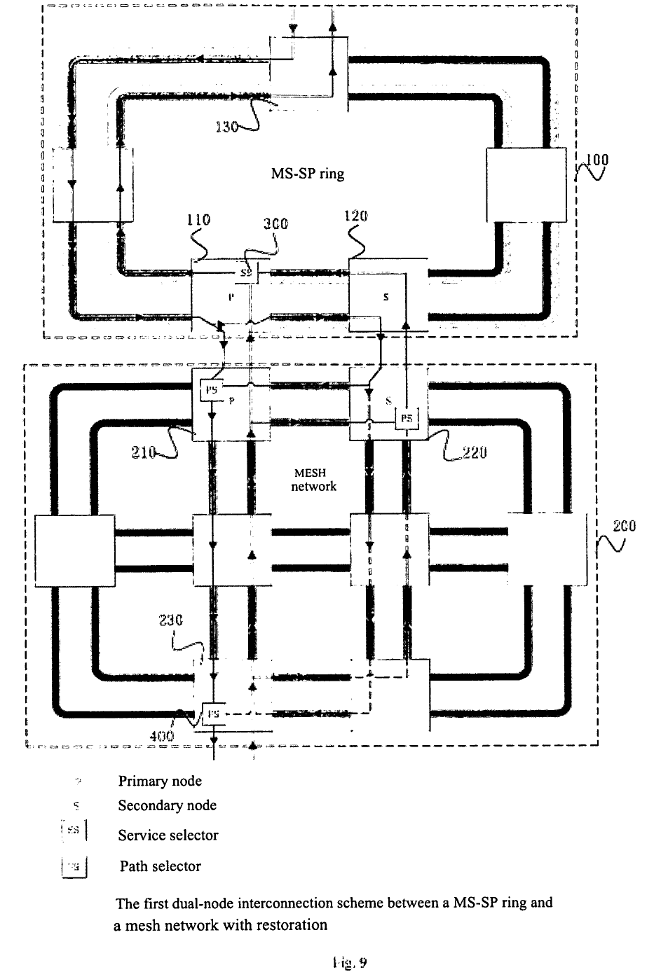

Before describing the dual-node interconnection between mesh networks and ring networks as well as between mesh networks for various topologies, the primary node and the secondary node in a mesh network should be defined. In the internetworking dual-node interconnection scheme for ring networks defined in G.842 standard, a MS-SP ring differentiates a primary node and a secondary node when two ring networks are dual-node connected, which is also complied with in the present invention. In addition, for the mesh network with restoration, among two nodes connecting with other network (regardless of a ring network or a mesh network), the primary node is defined as the one through which the working path is passing, and the secondary node is defined as the one used for backup path. Referring to FIG. 9, the MS-SP ring has the primary node P and the secondary node S, and the mesh network also has the primary node P and the second node S, as shown in the figure (the primary node and the secondary node are separately denoted by P and S in the figure).

The network node in the present invention can be implemented by, but no way limited to, SDH/SONET node equipment, OXC/optical add and drop multiplex (OADM) equipment, and DXC or ASON node equipment etc. In addition, the primary and secondary node follow the rule defined in G.842.

The FIGS. 8 through 36 will be described in detail one by one below.

FIG. 8 shows a dual-node interconnection structure and a path configuration scheme between a mesh network with SNCP and a MS-SP ring. The dual-node interconnection topology structure is used between the networks, SNCP is used in the mesh network, and MS-SP is used in the ring network. The path passed through the two networks have to make use of the two links between the two nodes residing in the ring network and the two nodes residing in the mesh network, respectively. The core of this interconnection structure is its path configuration and protection method. In the case of a uni-directional path transmitted from the ring network to the mesh network, the drop-and-continue function (after the end-to-end path reaching the destination, dropping and also bridging the path to the next section, referring to definition in ITU-T standard G.842) of the primary node (P in the figure, i.e. node 110) of the ring network will drop the path in the primary node 110 of the ring network and continue to transmit the uni-directional path to the secondary node of the ring network (S in the figure, i.e. node 120). The uni-directional path is then transmitted from the primary node 110 of the ring network to the node 210 of the mesh network, and at same time, the uni-directional path is continued to be transmitted from the secondary node 120 of the ring network to the node 220 of the mesh network through which it enters the mesh network. Two path are setup at the two border nodes (node 210 and node 220), through which the path enters the mesh network, to the destination node, namely node 230, which selects a path. Likewise, for the uni-directional path transmitted from mesh network to ring network, two paths are setup from the source to the two mesh network nodes connecting with the ring network, i.e. node 210 and node 220, through which the path enters the primary node 110 and the secondary node 120 of the ring network, respectively. Then through the ring network, the path on the secondary node 120 is looped back to the primary node 110, which performs path selection and transmits the selected path to the destination, namely node 130.

Because the interconnection between the ring network and the mesh network is a dual-node interconnection structure and the interconnection nodes have drop-and-continue function and path selection or path selection function, any single point failure in this interconnection structure can not break down the path passed between the ring network and the mesh network, therefore the path protection between the networks can be realized. The protection mechanism of the ring network protects the path in the ring network from failure in the ring network. And since SNCP is used to protect the path in the mesh network from failure in the mesh network, if the two paths in the mesh network do not fall into failure at the same time, the path will not be interrupted.

FIG. 9 shows a dual-node interconnection structure and the path configuration scheme between a mesh network with restoration and a MS-SP ring. Restoration is used in mesh network and MS-SP ring is used in ring network, and the path interconnection between the networks are implemented by two links between the two nodes residing in the ring network and the two nodes residing in the mesh network, respectively. The path selectors in the node 220 and 230 in the mesh network as shown in FIG. 9 are optional. The core of this interconnection structure is its path configuration and protection method: in the case of a uni-directional path transmitted from the node 130 of the ring network to the node 230 of the mesh network, the primary node of the ring network 110 will use its drop-and-continue function to make the path from the primary node 110 and the secondary node 120 of the ring network enter the mesh network at same time via the primary node 210 and the secondary node 220 of the mesh network, respectively. The path entering the secondary node 220 of the mesh network will be routed in the mesh network to the primary node 210 of the mesh network, which performs path selection, and a path is setup from the primary node 210 of the mesh network to the path destination node 230 as the working path for the path. Since in the mesh network the restoration scheme is used for the path, a backup path for the failure in the mesh network is setup from the secondary node 220 of the mesh network as the source node to the path destination node 230. The backup path can be selected flexibly depending on the real network situation, the dashed lines between the node 220 and the node 230 in the figure represent the path selected according to the shortest path algorithm, and of course, other backup path routes can also be chosen. At this time, the source of the working path and that of the backup path in the mesh network are not the same, hence the association between the working path and the backup path with different sources should be setup in order to activate the backup path when the working path falls into failure. With the above-mentioned scheme, the mesh network can provide restoration for services, and the backup paths of multiple services can share the same resource. For the centralized restoration process, the central network administration has comprehensive responsibility for the setup of the backup path when network failure occurs. For the distributed restoration process, there are several choices for the setting-up process of the backup path in the mesh network depending on the restoration strategy in the mesh network as follows:
1) The backup path is not setup for the path in the mesh network until receiving a notification message from the destination or the failure node, when a failure with the dropped path is confirmed in the mesh network, the path selection will be calculated in real time to setup a backup path;
2) although being pre-calculated, the backup path is not setup for the path in the mesh network until receiving a notification message from the destination or the failure node, when a failure with the dropped path is confirmed in the mesh network, the backup path will be setup;
3) although the backup path is pre-calculated and the resource for setting-up the backup path is pre-reserved with the signaling process but is not allocated, the backup path is not setup for the path in the mesh network until receiving a notification message from the destination or the failure node. When a failure with the dropped path is confirmed in the mesh network, the backup path will be setup;
4) although the backup path is pre-calculated and the resource for setting-up the backup path is pre-reserved with the signaling process and is allocated, the backup path is not setup for the path in the mesh network until receiving an alarm from the destination or the failure node. When a failure with the dropped path is confirmed in the mesh network, the backup path will be setup.

The steps in the four cases described above can be implemented by networking with distributed restoration-based OXC, DXC or ASON node equipment etc. In a distributed restoration situation, the above steps may be implemented by the distributed control processing unit (not shown) embedded in the relevant nodes in the network. Noted that because of the source or the destination of the working path and that of the backup path are not the same in the mesh network, the working path should be associated to the backup path when performing restoration.

As shown in FIG. 9, after a uni-directional path from the node 230 of the mesh network to the node 130 of the ring network enters the primary node 210 of the mesh network, drop-and-continue operation needs to be carried out on the path which enters the primary node 110 of the ring network and is bridged to the secondary node 220 of the mesh network. The path forwarded by the secondary node 220 of the mesh network is passed through the secondary node 120 of the ring network to the primary node 110 of the ring network, in which path selection is performed, then the path is passed to the destination node 130 through the ring network. A bi-directional path is the combination of two uni-directional services discussed above. An example of a bi-direction path is shown in FIG. 9.

With the dual-node interconnection structure between the ring network and the mesh network, and drop-and-continue function and trail selection function of interconnection nodes, any single point failure in such a interconnection structure can not break down the path passed between the ring network and the mesh network, therefore the internetworking path protection is accomplished. The protection mechanism of the ring network protects the path in the ring network from being interrupted. Regarding the failure occurring in the mesh network, for the uni-directional path from a node of the ring network to a node of the mesh network, the destination node of the mesh network or the node of the mesh network which has detected the failure sends the error message to the primary or secondary node of the mesh network via signaling communication network. After the failure located in mesh network is confirmed, the secondary node of the mesh network will initiate the restoration process to setup the backup path for path restoration according to the backup path information. For the uni-directional path from a node of the mesh network to a node of the ring network, the primary node of the mesh network is responsible for detecting the failure and determining whether the failure is in the mesh network. After the failure located in mesh network is confirmed, the primary node of the mesh network will report the failure to the source node via signaling communication network, then the source node initiates the restoration process to setup the backup path for path restoration to the node of the mesh network connected with the secondary node of the ring network. In this mesh node, the backup path is selected for this path and the path is sent into the secondary node of the ring network, hence the path is restored. The scheme described above is suitable for both uni-directional services and bi-directional services.

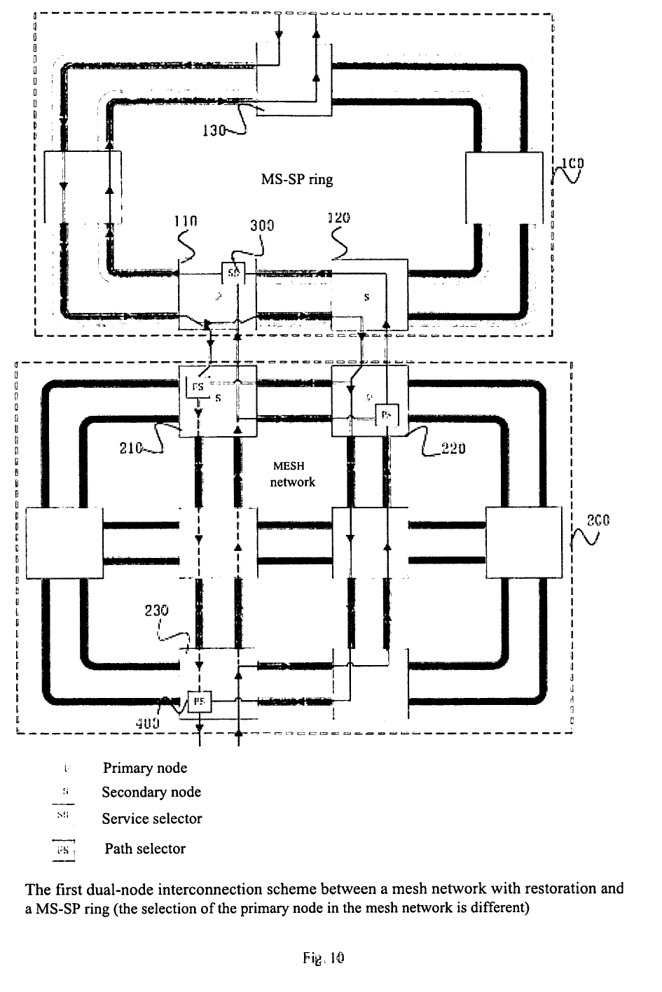

The primary node of the mesh network can also be the node 220 in FIG. 9, the path configuration scheme with the node 220 as the primary node is shown in FIG. 10. In this case, the working path is not setup in the mesh network when the path dropped at the primary node 110 of the ring network arrives at the node 210 of the mesh network, but the working path is setup when the path dropped at the secondary node 120 of the ring network arrives at the node 220 of the mesh network. When a failure takes place in the working path in the mesh network, the backup path is setup through the node 210 of the mesh network that is connected with the primary node 110 of the ring network. At this time, the primary node of the mesh network is the node 220, and the secondary node of the mesh network is the node 210. The process is the same as that described in FIG. 9.

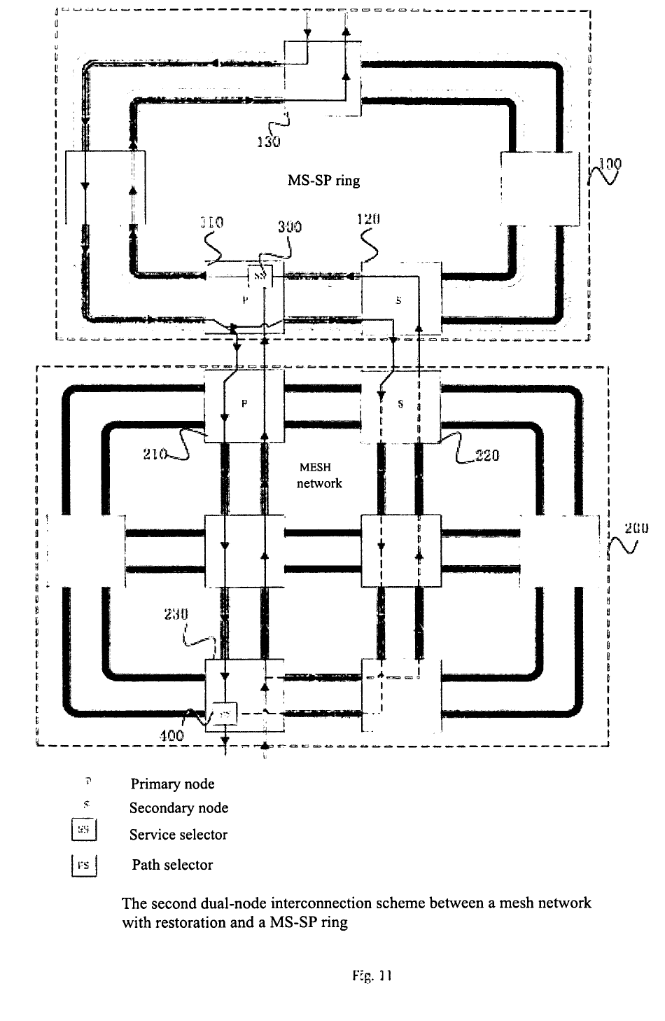

FIG. 11 is another exemplary scheme of the dual-node interconnection structure and the path configuration between a mesh network with restoration and MS-SP ring network. Comparing with the scheme shown in FIG. 9, the secondary node 120 of the ring network may only drop the path to the secondary node 220 of the mesh network, and then pass the reverse path to the primary node 110 of the ring network, which will use the path selector 300 to select the path. In the mesh network, the path from the secondary node 120 of the ring network is not transmitted through the secondary node 220 of the mesh network to the primary node 210 of the mesh network, and the path being transmitted from the mesh network to the ring network is not continued from the primary node 210 of the mesh network to the secondary node 220 of the mesh network. In the mesh network, the source node of the working path and the source node of the backup path are different for the path from the ring network to the mesh network, and the destination node of the working path and the destination node of the backup path are different for the reverse path from the mesh network to the ring network. In the figure, due to the working path passing through the node 210 in the mesh network, the node 210 is the primary node of the mesh network, and the node 220 is the secondary node of the mesh network. When no failure happens, the path transmitted from the primary node 110 of the ring network may pass through the mesh network via the primary node 210 of the mesh network and arrive at the destination node 230. The backup path is from the secondary node 220 of the mesh network to the destination node 230, but the backup path is not actually setup until there is a failure occurring in the working path. The path selector 400 in the destination node 230 of the mesh network in the figure is optional.

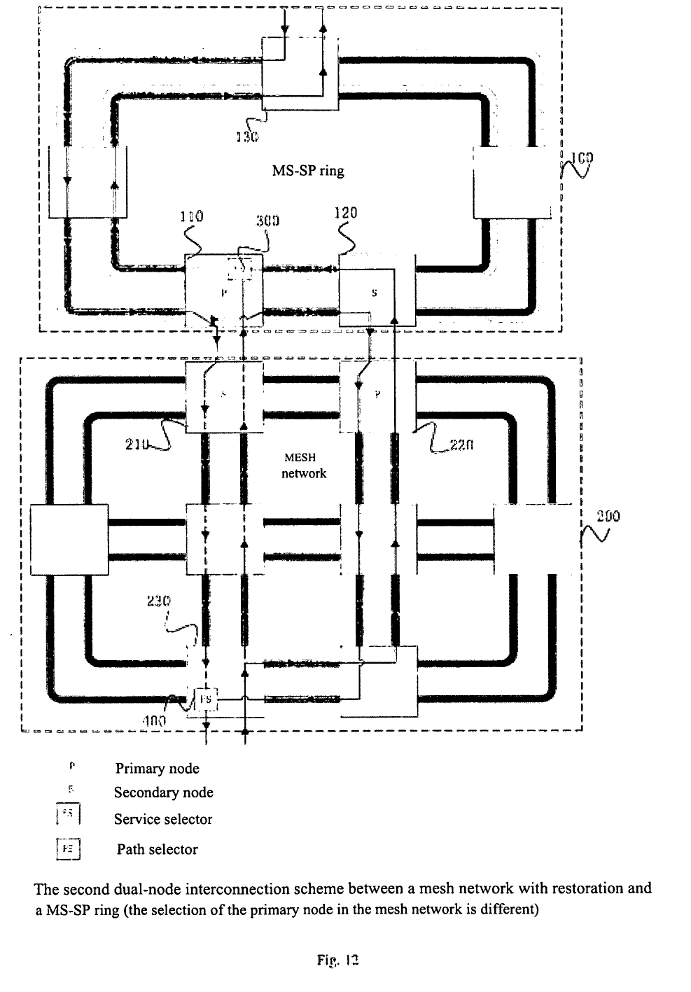

The node 220 can be selected as the primary node of the mesh network in FIG. 11, the path configuration scheme with the node 220 of the mesh network selected as the primary node of the mesh network is shown in FIG. 12. In this case, the path dropped from the secondary node 120 of the ring network instead of the one from the primary node 110 of the ring network is provided with a working path in the mesh network. When a failure takes place in the working path in the mesh network, the backup path will be setup through the secondary node 210 of the mesh network which is connected with the primary node 110 of the ring network. At this time, the primary node of the mesh network is the node 220, and the secondary node of the mesh network is the node 210. The process is same as that described in FIG. 11.

In the description below, the primary node of a mesh network is arbitrary in the case of a mesh network with restoration, and the detail is omitted for simplicity. FIGS. 10 and 12 can serve as reference for similar cases.

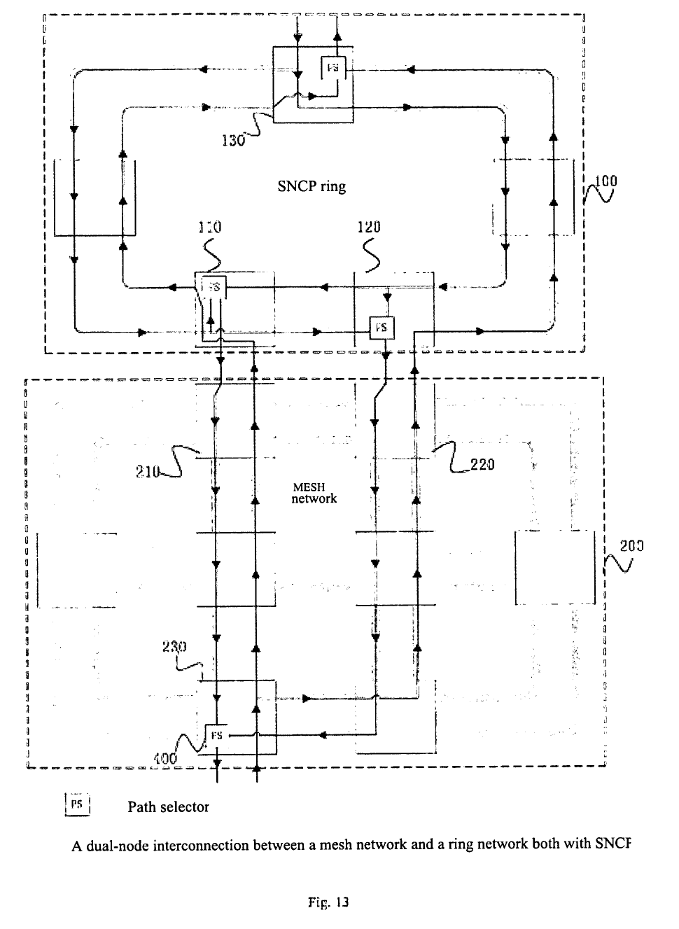

FIG. 13 shows the dual-node interconnection structure and the path configuration scheme between a mesh network and a ring network. SNCP is used in both the ring network and the mesh network and the dual-node interconnection structure is used between the networks. The detailed configuration of the path and the path selector 400 is shown in FIG. 13. The path is passed through the node 110 and the node 120 of the ring network to enter the node 210 and the node 220 of the mesh network, respectively, 1+1 path protection to the destination is setup, and the path selection is carried out in the destination node 230 of the mesh network and the destination node 130 of the ring network by the path selector 400. When any path from the ring network to the mesh network falls into failure, the path selector will make appropriate selection.

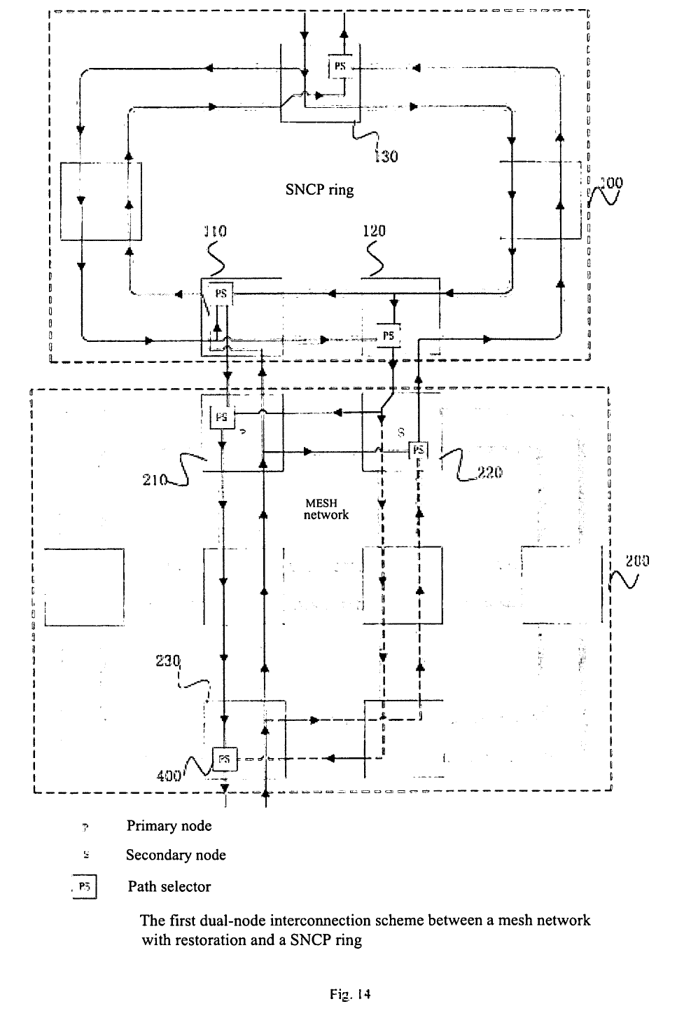

FIG. 14 shows the dual-node interconnection structure and the path configuration scheme between a mesh network with restoration and a SNCP ring network. In FIG. 14, SNCP is used in the ring network, restoration is used in the mesh network, and the dual-node interconnection topology structure is used between the networks. The configuration of the path in the networks is indicated in the Fig. by dashed arrows, solid arrows and path selectors. When there is a failure occurring in the ring network, the path is protected by 1+1 path protection of the ring network. When there is a failure occurring in mesh network, the path is protected by restoration in the mesh network. With the dual-node interconnection structure, the path between the two networks may be protected against both a node failure and a link failure, of which the method is similar to the interconnection structure described in FIG. 9. For example, when a failure occurs on the link between the node 110 of the ring network and the primary node 210 of the mesh network, the primary node 210 of the mesh network can select to receive only the path transmitted from the node 120 of the ring network and the secondary node 220 of the mesh network to receive, and the node of the ring network can select only the path transmitted from the secondary node 220 of the mesh network and the node 120 of the ring network to receive. Since the restoration of the mesh network is not carried out, the protection for this link failure is simple and fast. The path selector in the node 220 and the node 230 of the mesh network is optional.

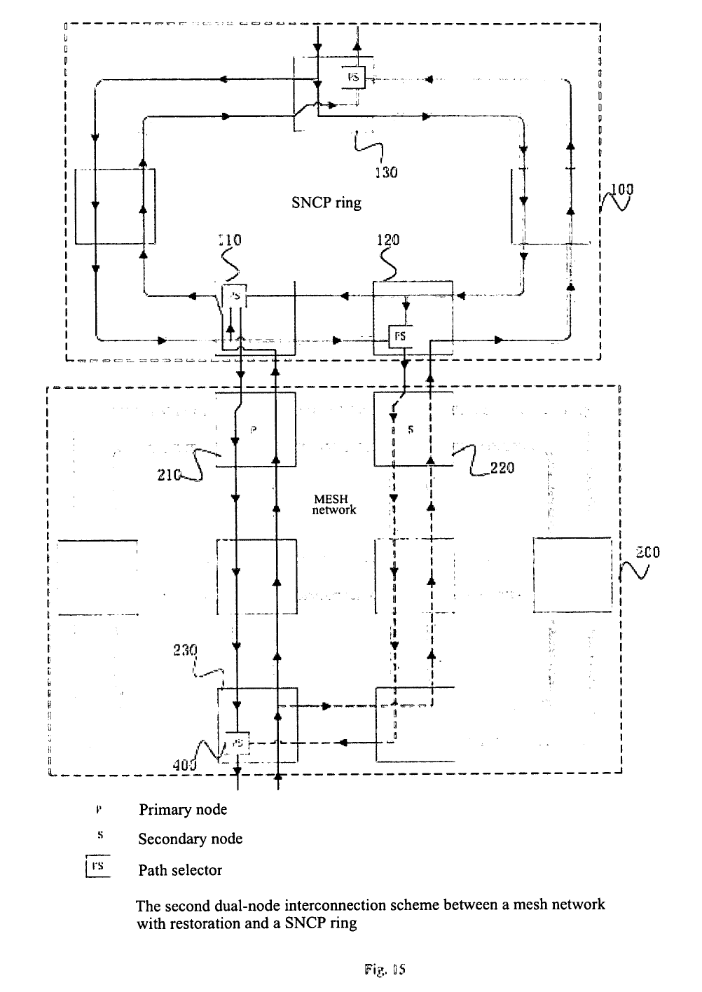

FIG. 15 shows another dual-node interconnection structure and path configuration scheme between a mesh network and a SNCP ring network. In FIG. 15, SNCP is used in the ring network, restoration is used in mesh network, and dual-node interconnection topology structure is used between the networks. The configuration of the path in the networks is indicated in the figure by dashed arrows, solid arrows and path selectors. When there is a failure occurring in the ring network, the path is protected by 1+1 path protection of the ring network. When there is a failure occurring in the mesh network, the path is restored in the mesh network. However in the mesh network, the primary node of the mesh network does not drop and continue the path to the secondary node of the mesh network, and the secondary node of the mesh network does not transmit the path received from the secondary node of the ring network to the primary node of the mesh network either, which results in the different protection and restoration processing scheme from that of FIG. 14 when there are some failures occurring between the networks. For example, when a failure occurs on the link between the node 110 of the ring network and the primary node 210 of the mesh network, restoration of the mesh network needs to be activated in order to setup a bi-directional path between the secondary node 220 of the mesh network and the node 230 of the mesh network for restoration of the path affected by the failure. In FIG. 15 the path selector in the node 230 of the mesh network is optional.

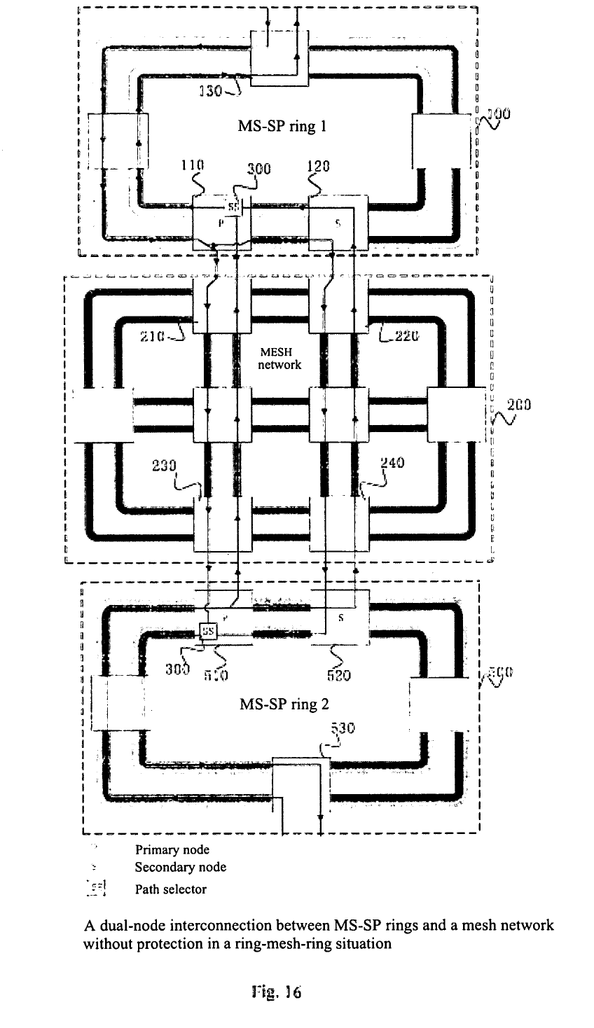

FIG. 16 shows the dual-node interconnection structure and the path configuration scheme between a mesh network without protection and two MS-SP ring networks. The inter-network path interconnection is carried out through the primary and secondary nodes of the ring networks, the mesh network and links therebetween. Two paths without protection are setup separately in the mesh network. With the drop and continue scheme, and due to the two paths respectively setup in the mesh network for connecting the path between the primary nodes of the two ring networks and the path between the secondary nodes of the two ring networks, the failures over the primary node or the secondary node of the ring networks can not interrupt the path, nor do the link failures and the node failures within the mesh network. Certainly the failure within the ring network is protected in the ring network.

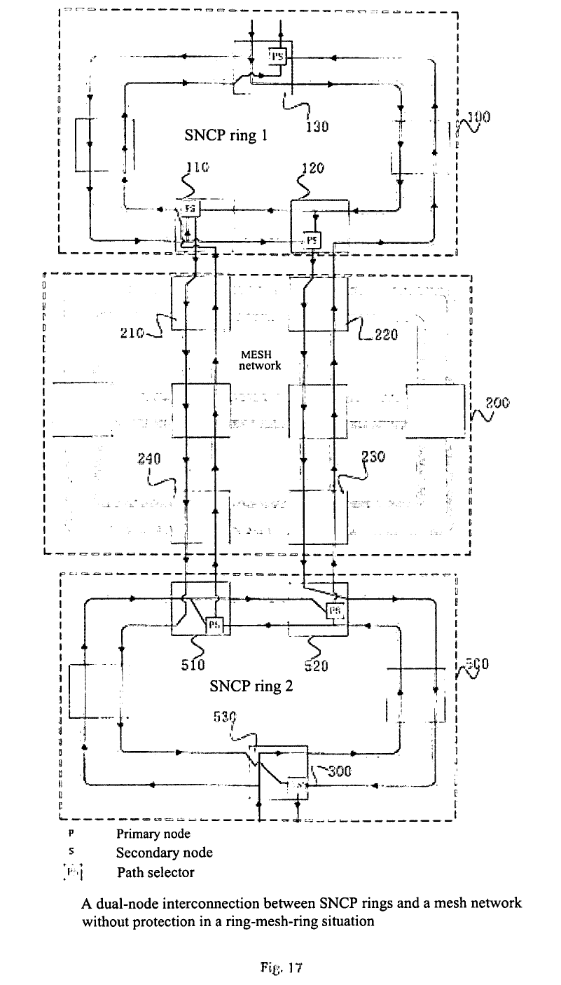

FIG. 17 shows the dual-node interconnection structure and the path configuration scheme between a mesh network without protection and two SNCP ring networks. With this dual-node interconnection structure, the protection can be made against various failures occurring within the rings, within the mesh network and between the ring networks and the mesh network.

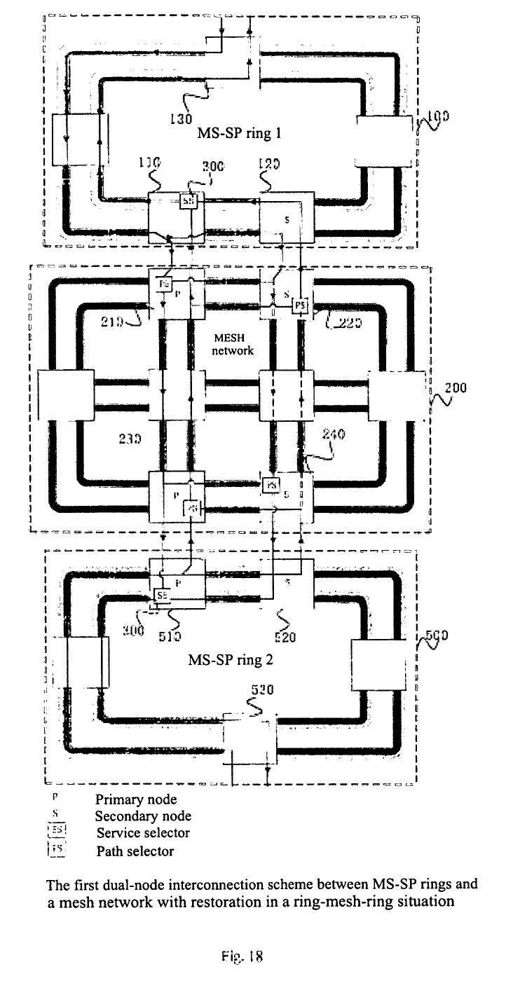

FIG. 18 shows the dual-node interconnection structure and the path configuration scheme in the case that two MS-SP ring networks are connected through a mesh network. With the dual-node interconnection structure shown in FIG. 18, the implementation of reliable protection and restoration can be guaranteed against various failures occurring within the rings, within the mesh network and between the ring networks and the mesh network. The path selectors in the nodes 220 and 240 of the mesh network are optional.

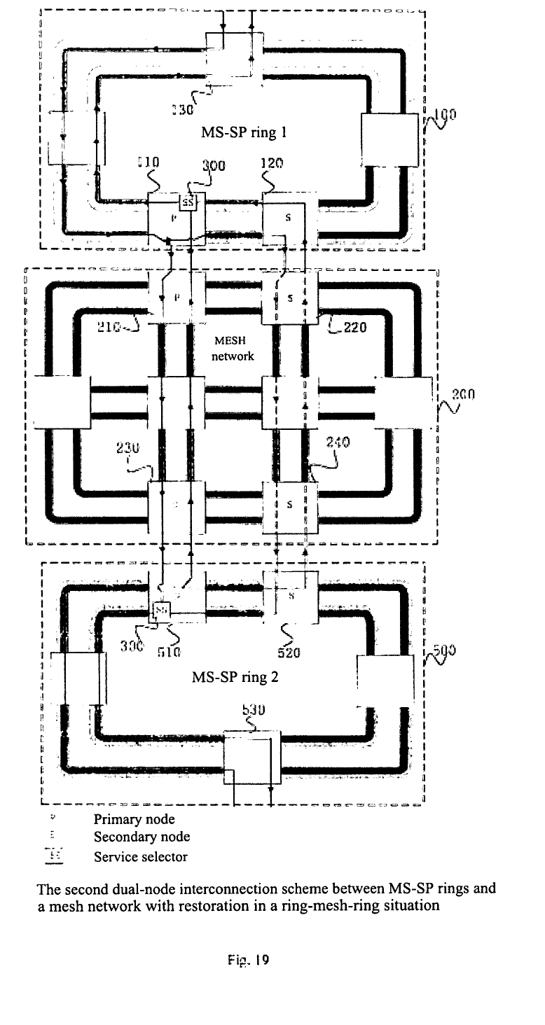

FIG. 19 shows the dual-node interconnection structure and the path configuration scheme in the case that two MS-SP ring networks are connected through a mesh network. Comparing with that of FIG. 18, the difference is that at the secondary nodes 220 and 240 of the mesh network, the services transmitted from the secondary nodes of the ring networks are not forwarded to the primary nodes of the mesh network, and at the primary nodes of the mesh network, the services to be transmitted out of the mesh network are not forwarded to the secondary nodes of the mesh network. With this interconnection structure, the implementation of protection and restoration can be guaranteed against various failures occurring within the rings, within the mesh network and between the ring networks and the mesh network.

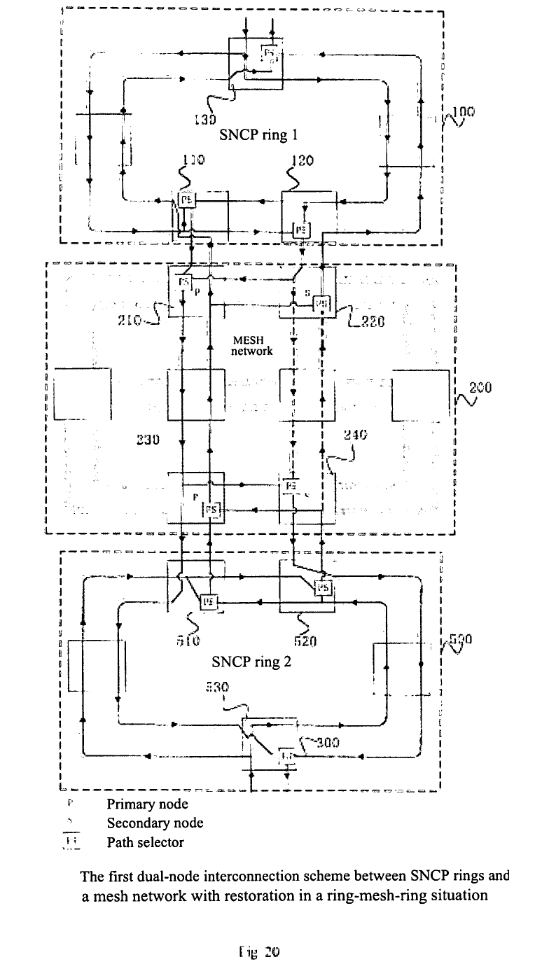

FIG. 20 shows the dual-node interconnection structure and the path configuration scheme in the case that two SNCP ring networks are connected through a mesh network. As shown in FIG. 20, the dropped and continued path from two ring networks are interconnected with the nodes 210, 220, 230, and 240 of the mesh network. The drop and continue function is used between the primary node and the secondary node of the mesh network. When a failure occurs on a working path in the mesh network, the backup path will be setup to restore the path affected by the failure. Due to the use of drop and continue function, the path between the networks can be protected from the failures. And the path can be protected by the protection mechanism in the ring network when failures happen in the ring network.

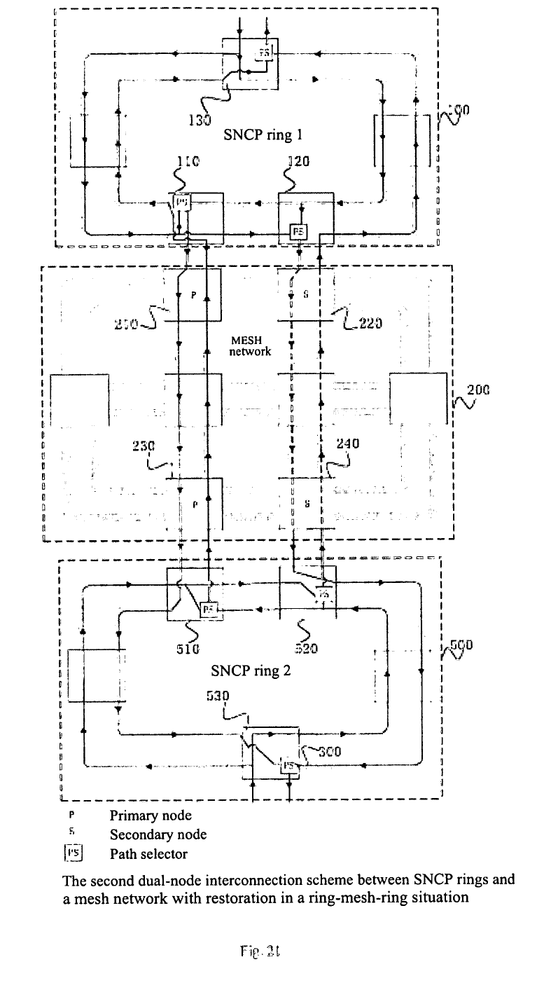

FIG. 21 shows the dual-node interconnection structure and the path configuration scheme in the case that two SNCP ring networks are connected through a mesh network with restoration. As shown in FIG. 21, the dropped and continued services from two ring networks are interconnected with the nodes 210, 220, 230, and 240 of the mesh network. The drop and continue function is not used between the primary nodes and the secondary nodes of the mesh network. The working path is setup between the node 210 and the node 230, and the resource for the backup path is reserved between the node 220 and the node 240 (vice versa, i.e. the working path can be setup between the node 220 and the node 240 and the resource for the backup path is reserved between the node 210 and the node 230). When the working path breaks down in the mesh network, the backup path will be setup to restore the path affected by the failure. Due to the use of drop and continue function, the path between the networks can be protected from the failures. And the path can be protected by the protection mechanism in the ring network when failures happen in the ring network.

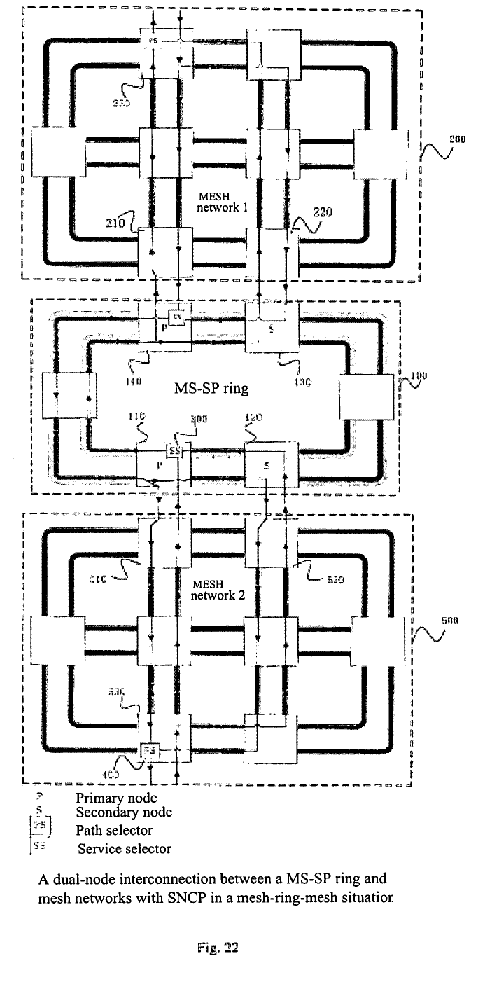

FIG. 22 shows the dual-node interconnection structure and the path configuration scheme in the case that two mesh networks with SNCP are connected through a MS-SP ring. The dual-node interconnection structure is used between the networks, and the drop and continue function is used by the MS-SP ring. The path to the destination is setup in both mesh networks 500 and 200 for the dropped and continued services from MS-SP ring 100, the path selection is carried out at the destination, and the path is sent to both paths in parallel at the source. The primary nodes of the MS-SP ring 100 perform path selection on the services coming from the mesh networks 200 and 500 by path selectors and transmit the path to other nodes. With this dual-node interconnection structure shown in FIG. 22, the implementation of protection can be guaranteed against various failures occurring within the rings, within the mesh network and between the ring networks and the mesh network.

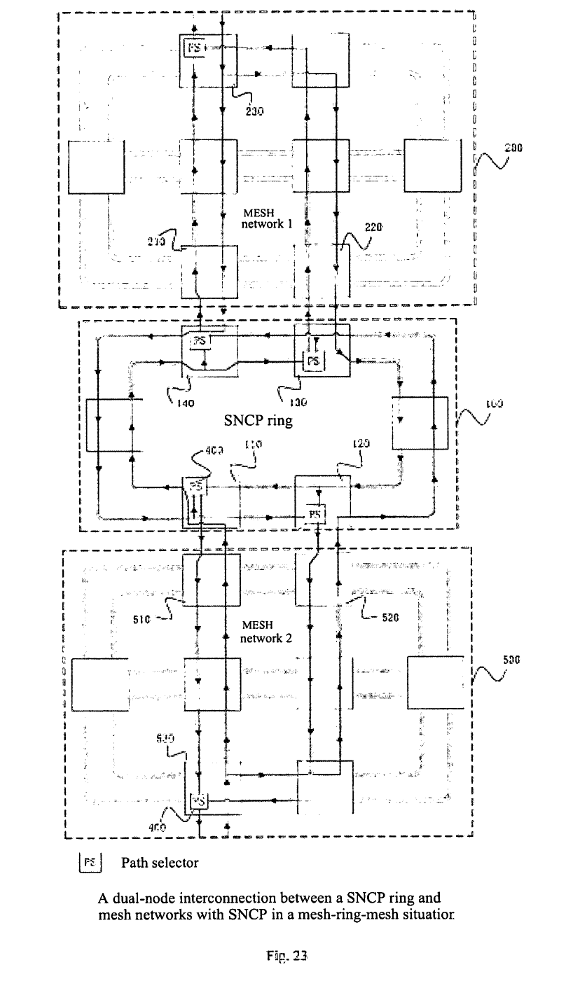

FIG. 23 shows the dual-node interconnection structure and the path configuration scheme in the case that two mesh networks with SNCP are connected through a SNCP ring. With this dual-node interconnection structure, the implementation of protection can be guaranteed against various failures occurring within the rings, within the mesh network and between the ring networks and the mesh network.

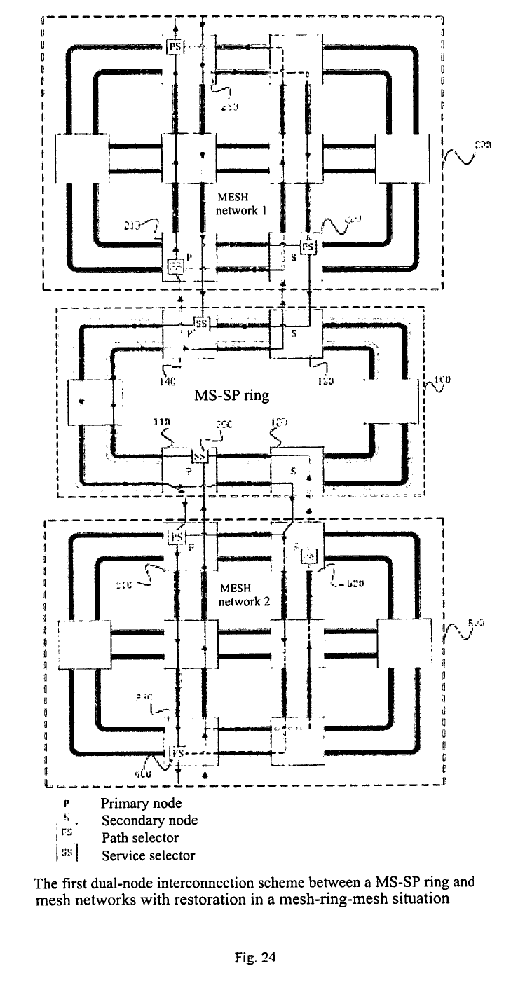

FIG. 24 shows the dual-node interconnection structure and the path configuration scheme in the case that two mesh networks with restoration are connected through a MS-SP ring. The dual-node interconnection structure in FIG. 24 is easy to understand by referring to the dual-node interconnection structure between a MS-SP ring and a mesh network described above. With the dual-node interconnection structure shown in FIG. 24, the implementation of protection and restoration can be guaranteed against various failures occurring within the rings, within the mesh network and between the ring networks and the mesh network. The path selectors in the nodes 220, 230, 520 and 530 of the mesh network are optional.

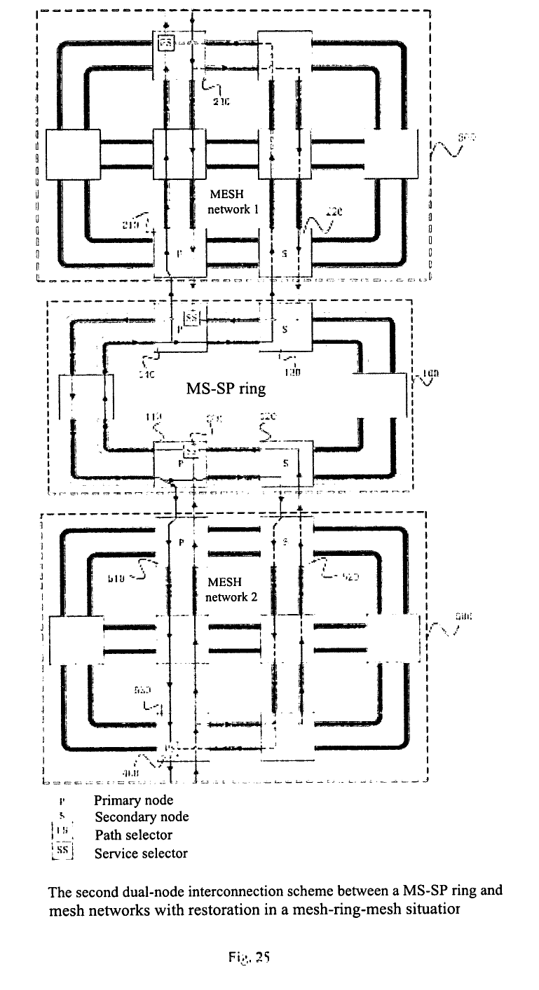

FIG. 25 shows another dual-node interconnection structure and path configuration scheme in the case that two mesh networks with restoration are connected through a MS-SP ring. With the dual-node interconnection structure shown in FIG. 25, the implementation of protection and restoration can be guaranteed against various failures occurring within the rings, within the mesh network and between the ring networks and the mesh network. The path selectors in the nodes 230 and 530 of the mesh network are optional.

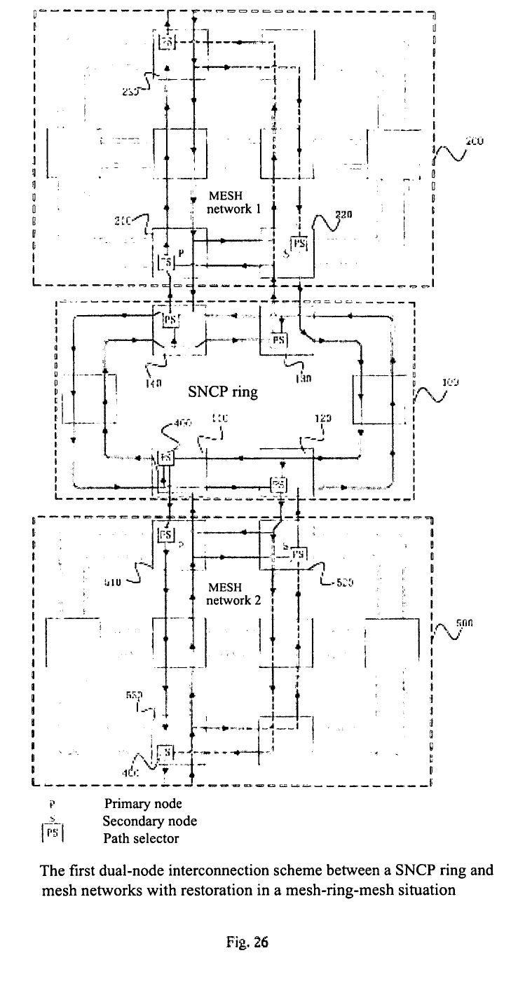

FIG. 26 shows the dual-node interconnection structure and the path configuration scheme in the case that two mesh networks with restoration are connected through a SNCP ring. With the dual-node interconnection structure shown in FIG. 26, the implementation of protection and restoration can be guaranteed against various failures occurring within the rings, within the mesh network and between the ring networks and the mesh network. The path selectors in the nodes 220, 230, 520 and 530 of the mesh network are optional.

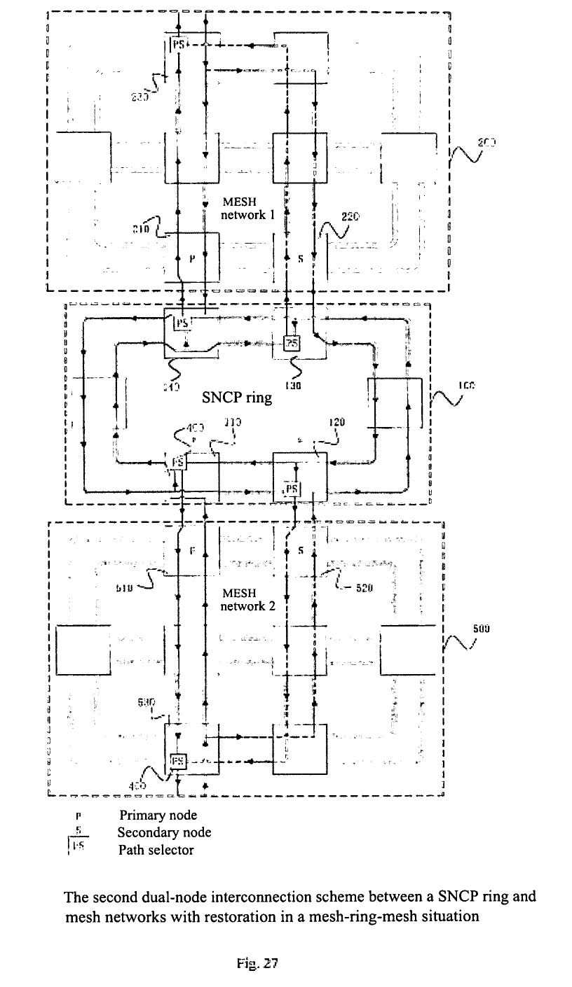

FIG. 27 shows another dual-node interconnection structure and path configuration scheme in the case that two mesh networks with restoration are connected through a SNCP ring. With the dual-node interconnection structure shown in FIG. 27, the implementation of protection and restoration can be guaranteed against various failures occurring within the rings, within the mesh network and between the ring networks and the mesh network. The path selectors in the nodes 230 and 530 of the mesh network are optional.

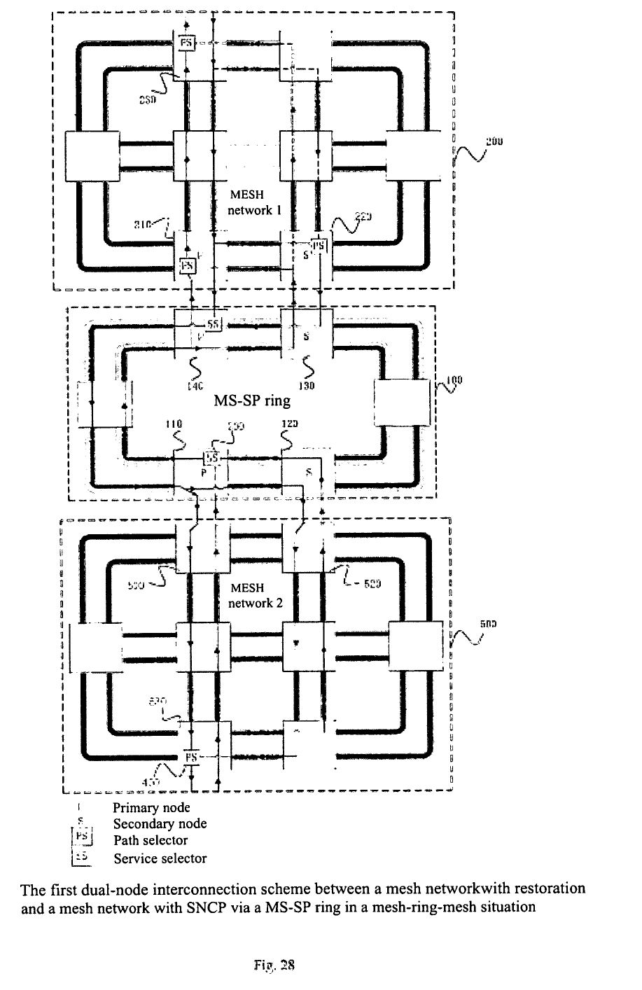

FIG. 28 shows the dual-node interconnection structure and the path configuration method in the case that two mesh networks are connected through a MS-SP ring, in which the mesh network 1 uses restoration and the mesh network 2 uses SNCP. With the dual-node interconnection structure shown in FIG. 28, the implementation of protection and restoration can be guaranteed against various failures occurring within the rings, within the mesh network and between the ring networks and the mesh network. The path selectors in the nodes 220 and 230 of the mesh network are optional.

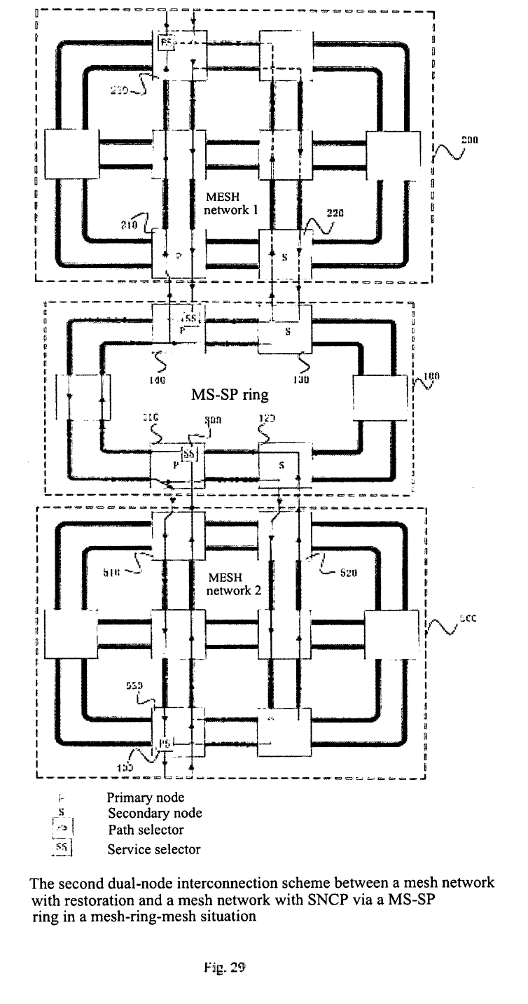

FIG. 29 shows another dual-node interconnection structure and path configuration method in the case that two mesh networks are connected through a MS-SP ring, in which the mesh network 1 uses restoration and the mesh network 2 uses SNCP. With the dual-node interconnection structure shown in FIG. 29, the implementation of protection and restoration can be guaranteed against various failures occurring within the rings, within the mesh network and between the ring networks and the mesh network. The path selectors in the nodes 230 and 530 of the mesh network are optional.

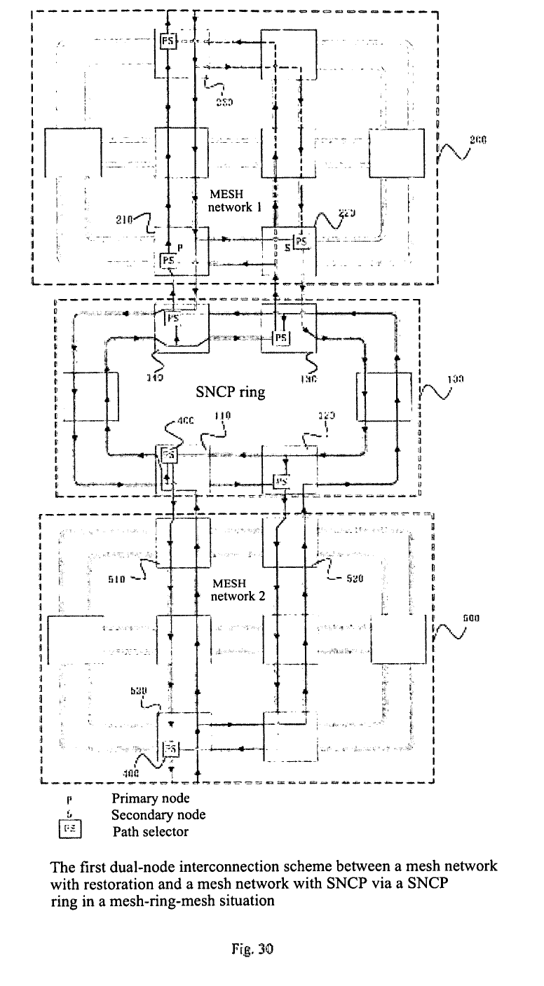

FIG. 30 shows the dual-node interconnection structure and the path configuration method in the case that two mesh networks are connected through a SNCP ring, in which the mesh network 1 uses restoration and the mesh network 2 uses SNCP. With the dual-node interconnection structure shown in FIG. 30, the implementation of protection and restoration can be guaranteed against various failures occurring within the rings, within the mesh network and between the ring networks and the mesh network. The path selectors in the nodes 220 and 230 of the mesh network are optional.

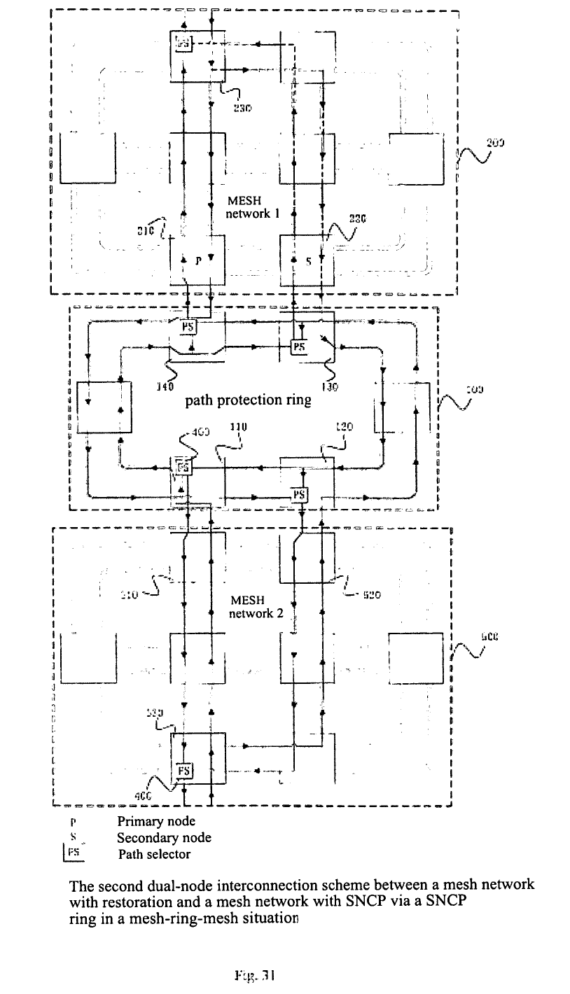

FIG. 31 shows another dual-node interconnection structure and path configuration method in the case that two mesh networks are connected through a SNCP ring, in which the mesh network 1 uses restoration and the mesh network 2 uses SNCP. With the dual-node interconnection structure shown in FIG. 31, the implementation of protection and restoration can be guaranteed against various failures occurring within the rings, within the mesh network and between the ring networks and the mesh network. The path selectors in the nodes 230 of the mesh network are optional.

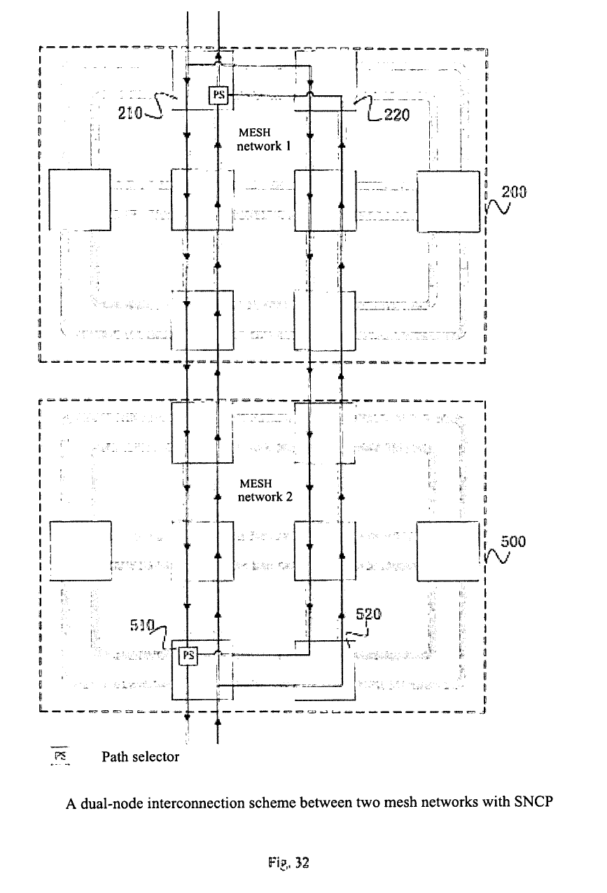

FIG. 32 shows the dual-node interconnection structure and the path configuration scheme between two mesh networks with SNCP. With the dual-node interconnection structure shown in FIG. 32, the implementation of protection can be guaranteed against various in-band failures within the mesh networks and between the mesh networks.

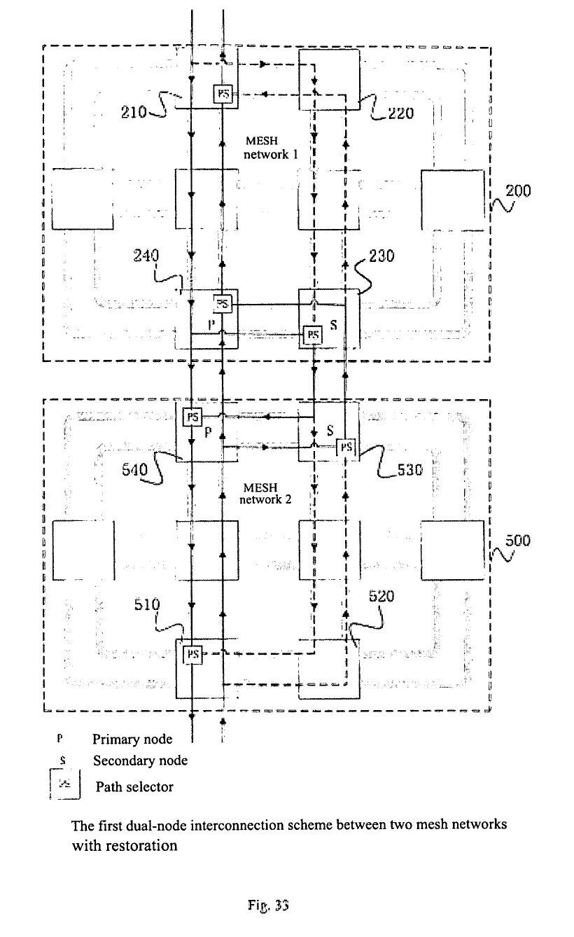

FIG. 33 shows the dual-node interconnection structure and the path configuration scheme between two mesh networks with restoration. With the dual-node interconnection structure shown in FIG. 33, the implementation of protection can be guaranteed against various in-band failures within the mesh networks and between the mesh networks. The path selectors in the nodes 210, 230, 510 and 530 of the mesh networks are optional.

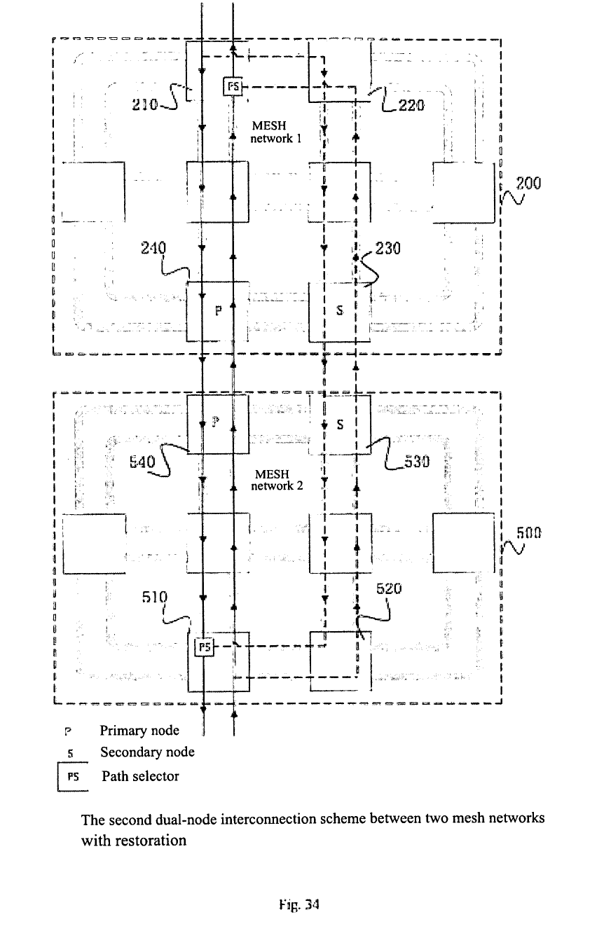

FIG. 34 shows the dual-node interconnection structure and the path configuration scheme between two mesh networks with restoration. The drop and continue function is not used for the path between the mesh networks. With the dual-node interconnection structure shown in FIG. 34, the implementation of protection can be guaranteed against various in-band failures within the mesh networks and between the mesh networks. The path selectors in the nodes 210 and 510 of the mesh networks are optional.

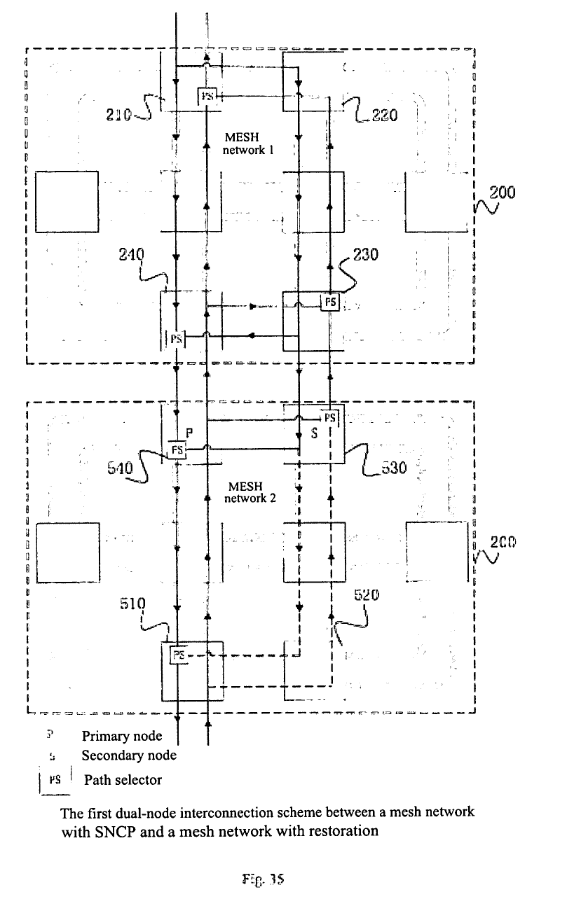

FIG. 35 shows the dual-node interconnection structure and the path configuration scheme between two mesh networks, in which the mesh network 1 uses SNCP, and the mesh network 2 uses restoration. The drop and continue function is used for the path between the mesh networks. With the dual-node interconnection structure shown in FIG. 35, the implementation of protection can be guaranteed against various failures within the mesh networks and between the mesh networks. The path selectors in the nodes 210 and 510 of the mesh networks are optional.

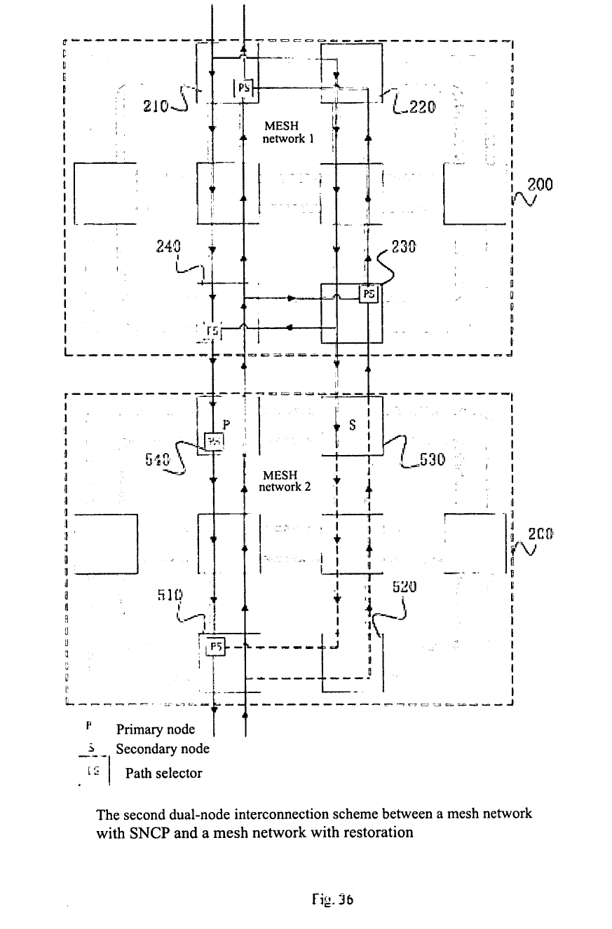

FIG. 36 shows another dual-node interconnection structure and path configuration scheme between two mesh networks, in which one mesh network uses SNCP, and the other network uses restoration. The drop and continue function is not used for the path between the mesh networks. With the dual-node interconnection structure shown in FIG. 35, the implementation of protection can be guaranteed against various in-band failures within the mesh networks and between the mesh networks. The path selector in the node 510 of the mesh network is optional

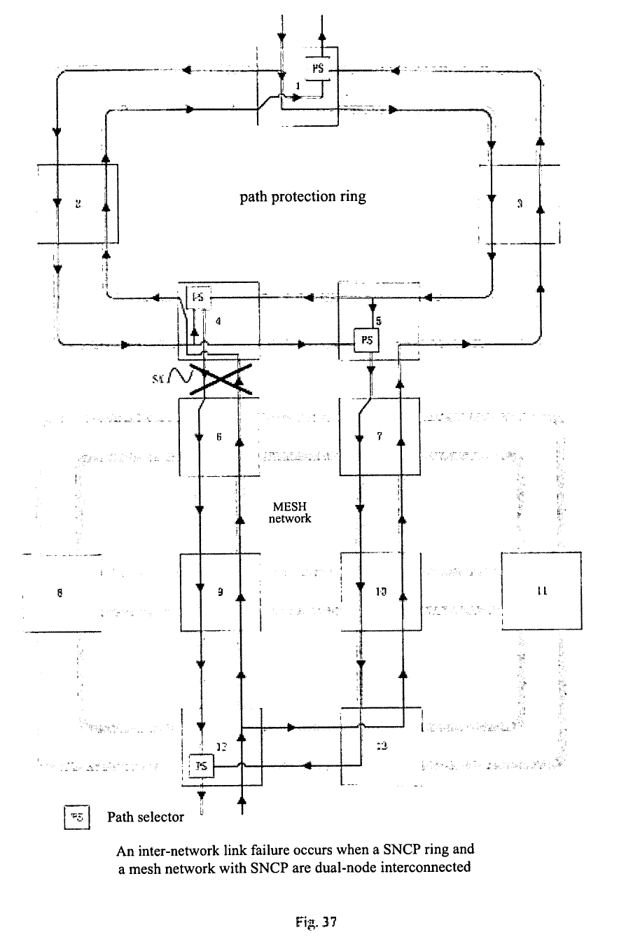

FIG. 37 shows the protection in a case that a failure occurs at the time that the interconnection is carried out between a SNCP ring network and a mesh network. A link failure between the networks happens to the path between the ring network and the mesh network, specifically, the location of the failure is indicated by SX in FIG. 37, a node failure happens to the interconnection node between the mesh network and the ring network. Since the node 1 and the node 12 are the destinations for the bi-directional path, the path selector in the destination node 1 and the path selector in the destination node 12 may select the path on the other path to achieve protection. In the case shown in FIG. 37, regardless of the location of the failure, there will be corresponding path selector to carry out appropriate path selection in order to guarantee the path with the protection against a failure in the ring, in the mesh network and between the networks. In addition, The reliable path protection can be provided against the link failure occuring on other path rounte in the mesh network, the node failure occuring on the path route in the mesh network, the link failure occuring on the interconnection link between the mesh network and the ring network, and the node failure occurring at the interconection node between the mesh network and the ring network.

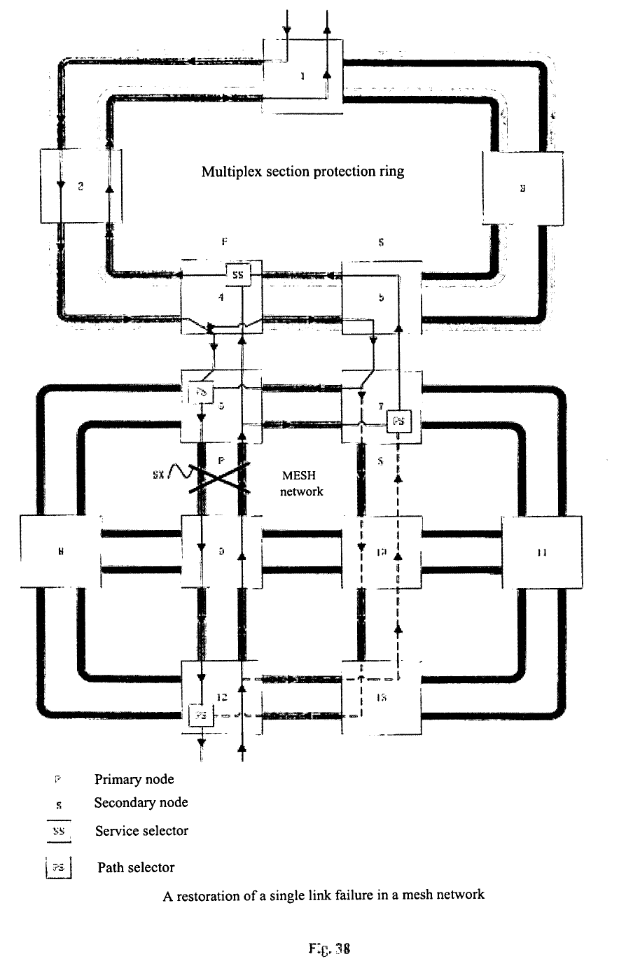

FIG. 38 shows an example of the restoration in the case that a failure occurs in the mesh network when a SNCP ring and a mesh network is dual-node interconnected. When a link failure in the mesh network with the location indicated in FIG. 38 happens to the interaction path between the ring network and the mesh network, the failure will be detected by the nodes 12, 9 and 6 and the node 7 will be noticed about the failure, if the node 7 and the node 12 determine that the failure node is within the mesh network according to the local information, the nodes 7 and 12 will initiate restoration process, a backup path will be setup by signaling along the restoration route indicated by dashed lines in FIG. 38, and the path selector in the node 4 will perform selection again. The restoration process is the same as described above when a failure happens to a node in the mesh network. In this embodiment, the path selector in Node 7 and Node 12 in FIG. 38 are not used. The presence or absence of the path selectors in the nodes 7 and 12 does not affect the protection and restoration process for the failure, the only difference will be the specific implementation.

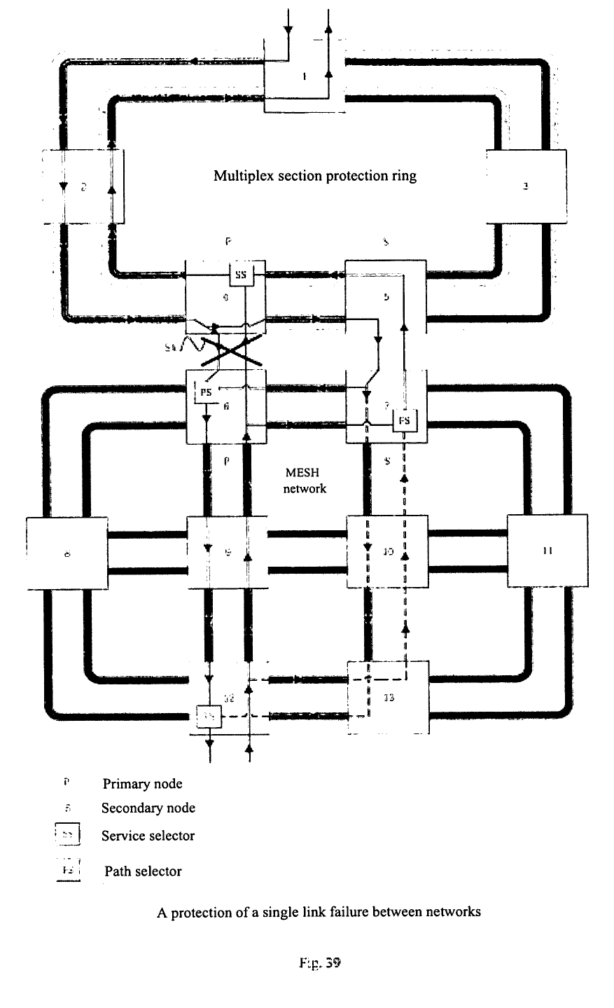

FIG. 39 shows an example of the restoration in the case that a link failure occurs between the networks when a MS-SP ring and a mesh network is dual-node interconnected. When a link failure happens to the link between the networks for the interconnection path between the ring network and the mesh network, the local link failure may be detected by the nodes 4 and 6, the path selector of the node 4 and the path selector of the node 6 will perform selection to pick up one from the two services in order to assure the path transmission. The path selectors in the node 7 and the node 12 in this embodiment are optional.

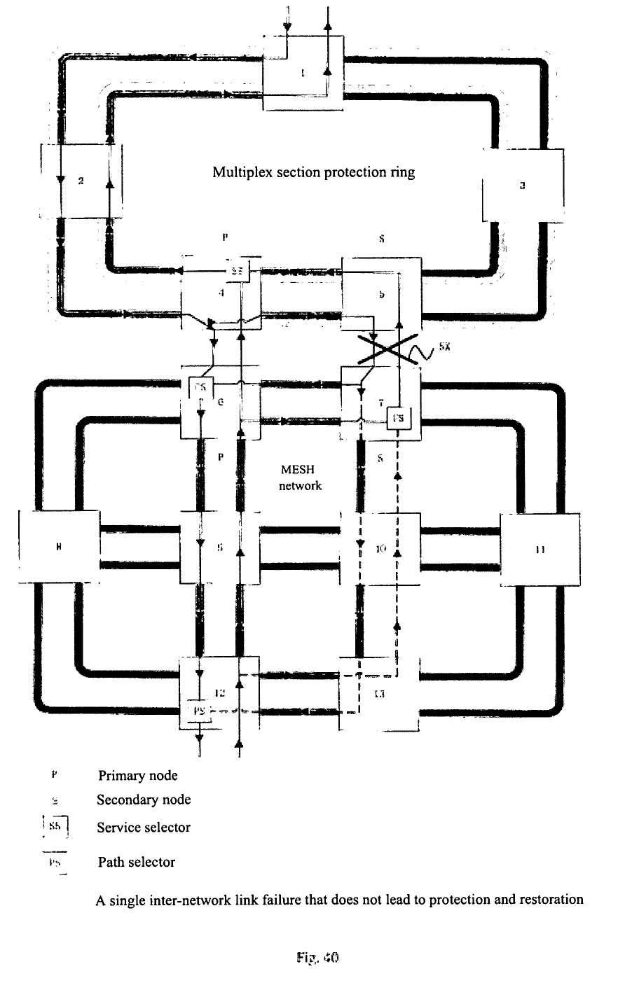

FIG. 40 shows an example of a link (the link connected with the secondary node of the ring network) failure occuring between networks when a MS-SP ring and a mesh network with restoration is dual-node interconnected. The link failure for the link between the networks happens to the interconnected path between the ring network and the mesh network, the location of the failure is shown in FIG. 40. At this time, the node 5 and the node 7 may have been detected the failure which does not affect the path, so the protection and restoration will not be initiated by the ring network or the mesh network. Actually, the protection and restoration will not be initiated by the ring network or the mesh network when a failure happens to the secondary node of the ring network, the secondary node of the mesh network, the link between the primary node and the secondary node of the mesh network, as well as the link between the primary node and the secondary node of the ring network. In this embodiment, the path selectors in the node 7 and the node 12 shown in FIG. 40 are optional.

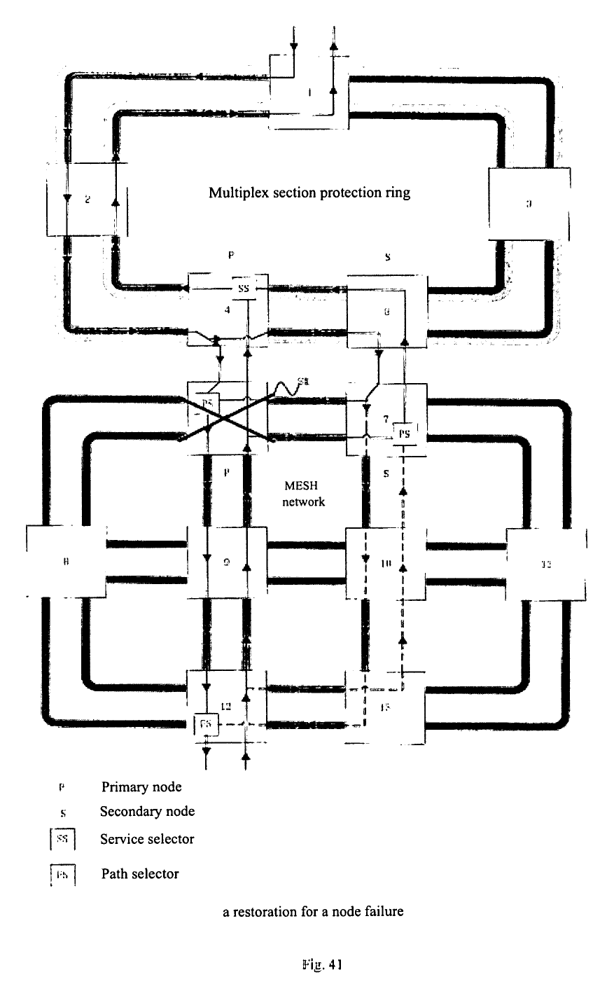

FIG. 41 shows an embodiment in the case that a failure occurs at the primary node of the mesh network when a MS-SP ring and a mesh network with restoration is dual-node interconnected. At this time, the restoration will be initiated by the secondary node of the mesh network for setting-up the backup path between the secondary node of the mesh network and the node 12 of the mesh network, in order to restore the affected path interrupted by the failure. In this embodiment, the path selectors in the node 7 and the node 12 shown in FIG. 41 are optional.

The embodiments of the various failure processing shown in FIG. 37 through FIG. 41 can be applicable to the various networking cases with the inter-network dual-node interconnection configuration scheme shown in FIG. 8 through 36. The implementation of the protection and restoration can be guaranteed against various failures in the ring, in the mesh network as well as between the ring network and the mesh network for the path configuration schemes in FIGS. 8-36. For simplicity, details are omitted here.

In a mesh network, 1+1 path protection has a number of advantages like high reliability, fast restoration and easy implementation with a tradeoff of 50% resource redundancy; the restoration scheme can reduce the redundancy dramatically but cost more time for restoration compared with 1+1 path protection and relatively complicated implementation for guaranteeing its reliability. Regarding these two schemes, the inter-network path interconnection in various network topology cases has been described as above.

When there is a failure occurring in the networks then the path restoration is needed, the protection and restoration can be initiated according to the location of the failure. If the failure occurs in the ring, then the protection mechanism of the ring network itself will be initiated; if the failure occurs in the interconnection link between networks, the path will not be interrupted due to the implementation of the dual-node interconnection structure; and if the failure occurs in the mesh network, then the corresponding restoration process will be initiated and carried out by signaling in the mesh network or the protection in the mesh work will be used.

The interconnection structures and the failure processing methods according to the invention are suitable for the interconnection of the inter-network path for the networking scheme like mesh network-ring network, ring network-mesh network-ring network, and mesh network-ring network-mesh network. Regarding the above various network topologies, the interconnection structures and the failure processing methods according to the invention are applicable to the inter-network path interconnection for the networking scheme with the various arbitrary combination of ring networks and mesh networks.

It is obvious that a person skilled in the art can modify the shown arrangements in many ways without departing from the gist of the invention which is encompassed by the subsequent claim.

1. A method for configuring interconnection between optical networks including a first network and a second network each including a plurality of nodes, a first node of the first network being connected with a third node of the second network and a second node of the first network being connected with a fourth node of the second network, said method comprising the steps of:
(a) setting-up a first path between one of the first node and the second node and another node in the first network; and
(b) via the first path and at least one of the link between the first node and the third node and the link between the second node and the fourth node, setting up the path between said another node in the first network and another node in the second network,
wherein at least one of said first network and said second network is a mesh network.

2. The method according to claim 1, wherein said another node in the first network is a source node or the destination node, while said another node in the second network is a corresponding destination node or source node, and the path is from the source node to the destination node.

3. The method according to claim 2, wherein the first network is a mesh network and the second network is a ring network, and the third node and the fourth node have drop-and-continue function.

4. The method according to claim 3, further comprising the step of: if SNCP is used in the mesh network, besides setting-up the first path, a second path is setup between said another node in the first network and one of the first node and the second node which is not used for setting-up the first path.

5. The method according to claim 4, wherein for a path from the ring network to the mesh network, the first path and the second path is selected at the destination node to receive the path; and for the path from the mesh network to the ring work, the source node transmits the path to the first path and the second path in parallel.

6. The method according to claim 3, further comprising the steps of: if the restoration scheme is used in the mesh network, a restoring path is setup between said another node of the first network and one of the first node and the second node which is not used for setting-up the first path, wherein the node in the first network used for setting-up the first path is the primary node, and the node used for setting-up the restoring path is the secondary node.

7. The method according to claim 6, wherein the path transmitted from the ring network to the mesh network enters the primary node and the secondary node in the mesh network via the third node and the fourth node, respectively.

8. The method according to claim 7, wherein the path of the fourth node is routed to the third node, and the path selection is carried out at the third node.

9. The method according to claim 6, wherein the path transmitted from the ring network to the mesh network enters the primary node and the secondary node in the mesh network via the fourth node and the third node, respectively.

10. The method according to claim 9, wherein the path at the third node is routed to the fourth node, and the path selection is carried out at the fourth node.

11. The method according to claim 7, wherein the path entering the secondary node is routed to the primary node, and the path selection is carried out at the primary node, and the path is transmitted to the destination node via the first path, wherein the primary node and the secondary node have drop-and-continue function.

12. The method according to claim 6, wherein after entering the third node and the fourth node, respectively, the path transmitted from the mesh network to the ring network is routed to the third node from the fourth node, the path selection is carried out at the third node, and the selected path is passed to the destination node via the ring network.

13. The method according to claim 12, wherein the path enters the secondary node from the primary node in the mesh network, then enters the third node and the fourth node in the ring network via the primary node and the secondary node, respectively.

14. The method according to claim 6, wherein after entering the third node and the fourth node, respectively, the path transmitted from the mesh network to the ring network is routed from the third node to the fourth node, the path selection is carried out at the fourth node, and the selected path is passed to the destination node via the ring network.

15. The method according to claim 14, wherein the path enters the secondary node from the primary node in the mesh, then enters the fourth node and the third node in the ring network via the primary node and the secondary node, respectively.

16. The method according to claim 12, wherein the path enters the third node and the fourth node from the primary node of the mesh network.

17. The method according to claim 6, wherein the first path is associated with the backup path, and the backup path is used as a working path when the first path falls into failure.

18. The method according to claim 6, wherein the setting-up scheme of the backup path is: when receiving a notification message from the destination node or the failure node and having confirmed the failure is in the mesh network, the restoration path selection is calculated in real time and the backup path is setup.

19. The method according to claim 6, wherein the setting-up scheme of the backup path is: the backup path is pre-calculated, and the backup path is setup when receiving the notification message from the destination node or the failure node and having confirmed the failure is in the mesh network.

20. The method according to claim 6, wherein the setting-up scheme of the backup path is: the backup path is pre-calculated, the resource required for setting-up the path is reserved in advance by signaling process, and the backup path is setup when receiving a notification message from the destination node or the failure node and having confirmed the failure is in the mesh network, wherein the resource is not allocated when reserving the resource in advance.

21. The method according to claim 6, the backup path is pre-calculated, the resource required for setting-up the path is reserved in advance by signaling process, and the backup path is setup when receiving a notification message from the destination node or the failure node and having confirmed the failure in the mesh network, wherein the resource is allocated when reserving the resource in advance.

22. The method according to claim 6, wherein for the path transmitted from the ring network to the mesh network, if the failure happens in the mesh network, the destination node or other nodes in the mesh network which have detected the failure send a notification message about the failure to the primary node or the secondary node in the mesh network via signaling network, having determined that the failure is located within the mesh network, the secondary node initiates the restoration process and setup a backup path based on information on the backup path to restore the path.

23. The method according to claim 6, wherein for the path transmitted from the mesh network to the ring network, if the failure happens within the mesh network, the failure will be detected by the primary node in the mesh network and the node at the side of the failure node, if it is determined that the failure is in the mesh network, a notification message will be sent to the source node via signaling network, and the source node will initiate the restoration process to setup the backup path to the secondary node for the path, the path of the backup path is selected at the secondary node through which the path of the backup path enters the ring network, therefore the path is restored.

24. The method according to claim 6, wherein for the bi-directional path between the mesh network and the ring network, if the failure happens within the mesh network, the failure will be detected by the corresponding destination node and the nodes at both sides of the failure node in the mesh network which will determine that the failure occurs in the mesh network, a notification message will be sent to the source node/destination node via the signaling network, the source node/destination node will initiate a restoration process for setting-up the backup path to the secondary node for the bi-directional path so as to restore the path.

25. The method according to claim 1, wherein both the first network and the second network are mesh networks.

26. The method according to claim 1, wherein a plurality of the first networks are interconnected with a plurality of the second networks.

27. The method according to claim 25, wherein all of the first, the second, the third and the fourth nodes all have drop-and-continue function and path selection function.

28. An inter-network interconnection structure of optical networks, comprising:
a first network having a plurality of nodes including a first node and a second node;
a second network having a plurality of nodes including a third node and a fourth node, the first node being connected with the third node and the second node being connected with the fourth node;
a first path for connecting the first node or the second node with another node in the first network;
wherein the path communication is performed between said another node in the first network and another node in the second network via the first path and at least one of the link between the first node and the third node and the link between the second node and the fourth node,
wherein at least one of said first network and said second network is a mesh network.

29. The inter-network interconnection structure according to claim 28, wherein said another node in the first network is a source node or a destination node, while said another node in the second network is the corresponding destination node or source node, the path is transmitted from the source node to the destination node.

30. The inter-network interconnection structure according to claim 28, further comprising a second path setup between said another node in the first network and one of the first node and the second node which is not used for setting-up the first path.

31. The inter-network interconnection structure according to claim 30, wherein the first path and the second path is selected at the destination node to receive the path, and the source node transmits the path to the first path and the second path in parallel.

32. The inter-network interconnection structure according to claim 29, further comprising a backup path setup between said another node in the first network and one of the first node and the second node which is not used for setting-up the first path.

33. The inter-network interconnection structure according to claim 32, further comprising: a distributed control processing unit, which is located in or connected electrically with the respective nodes and is used for setting-up the backup path based on different restoration strategies adopted by the first network.

34. The inter-network interconnection structure according to claim 29, wherein the node can be any of SDH/SONET node equipment, OXC equipment, OADM equipment, DXC equipment or ASON equipment.

35. The inter-network interconnection structure according to claim 29, wherein the first network is a mesh network and the second network is a ring network.

36. The inter-network interconnection structure according to claim 29, wherein both the first network and the second network are mesh networks.

37. The inter-network interconnection structure according to claim 31, further including path selectors which are used for the selection of the first path and the second path.

38. The method according to claim 9, wherein the path entering the secondary node is routed to the primary node, and the path selection is carried out at the primary node, and the path is transmitted to the destination node via the first path, wherein the primary node and the secondary node have drop-and-continue function.

39. The method according to claim 14, wherein the path enters the third node and the fourth node from the primary node of the mesh network.

40. The method according to claim 2, wherein both the first network and the second network are mesh networks.

41. The method according to claim 2, wherein a plurality of the first networks are interconnected with a plurality of the second networks.

42. The inter-network interconnection structure according to claim 30, wherein the first network is a mesh network and the second network is a ring network.

43. The inter-network interconnection structure according to claim 32, wherein the first network is a mesh network and the second network is a ring network.

44. The inter-network interconnection structure according to claim 30, wherein both the first network and the second network are mesh networks.

45. The inter-network interconnection structure according to claim 32, wherein both the first network and the second network are mesh networks.
